(19) United States
(12) Patent Application Publication
(10) Pub. No.: US 2023/0325859 A1
(43) Pub. Date: Oct. 12, 2023

(54) DYNAMIC DATA SET PARSING FOR VALUE MODELING

(71) Applicant: AON RISK SERVICES, INC. OF MARYLAND, New York, NY (US)

(72) Inventors: Samuel Cameron Fleming, Spokane, WA (US); Rohitasva Dutta, New York, NY (US); Adam Parish, Spokane, WA (US)

(21) Appl. No.: 17/718,203

(22) Filed: Apr. 11, 2022

(51) Int. Cl. G06Q 30/02; G06Q 10/06

(52) U.S. Cl. CPC G06Q 30/0204; G06Q 10/067

(57) ABSTRACT

Systems and methods for generation and use of intellectual-property (IP) analysis platform architectures are disclosed. A value modeling component may be utilized to generate financial metrics for IP assets using user seeded searches in varying areas of interest, such as, for example, target technical fields, targeted publications, targeted products, and/or target entity portfolios. The value modeling component may be further utilized to produce an interactive graphical element including a spatial representation of the financial metrics associated with the IP assets. The interactive graphical element may include various functionalities and/or information associated with the of IP assets. The value modeling component may utilize data from a coverage component, an opportunity component and/or an exposure component to assess a comprehensive score associated with a group of IP assets of a targeted entity.

### BACKGROUND

Analyzing an intellectual-property portfolio of a particular entity with respect to one or more entities having a similar intellectual-property portfolio may provide various insights and can be valuable. However, it can be difficult to identify information that can be derived from data that has rarely been analyzed and it can also be challenging to determine which types of data can be utilized to make decisions. Disclosed herein are improvements in technology and solutions to technical problems that can be used to, among other things, analyze and generate visual representations of intellectual-property portfolios of various entities.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for an intellectual-property analysis platform architecture.

FIG. 2 illustrates a component diagram of example components of a remote computing resource for the intellectual-property analysis platform.

FIG. 3 illustrates an example user interface for displaying data associated with a user account representing intellectual-property score data and/or one or more actionable elements.

FIG. 4 illustrates an example user interface for displaying data associated with a user account representing an intellectual-property score data and/or one or more actionable elements.

FIG. 5 illustrates an example flow diagram of an example process for utilizing a target entity having IP assets generate a user interface configured to present an analysis of the IP assets.

FIG. 6 illustrates an example flow diagram of an example process for analyzing IP assets and receiving user input indicating screening metrics.

### DETAILED DESCRIPTION

Systems and methods for generation and use of an intellectual-property analysis platform are disclosed. Take, for example, an entity that would find it beneficial to utilize a platform to analyze a corpus of intellectual-property (IP) assets in an efficient manner by targeting technical fields, subject matters, and/or target entities and to determine insights associated with the entities that own and/or are otherwise assigned to the IP assets. For example, an entity may desire to know financial data associated with a potential investment entity that the purchasing entity may be interested in acquiring. In some cases, the purchasing entity may desire to know a comprehensive breadth score, revenue alignment data, filing frequency data, or litigation campaign data associated with the IP assets associated with a technical field, a subject matter, and/or potential investment entities for acquisition purposes. Generally, a user may search a database of such documents using keyword searching, such as, for example, a technical term, a target product, or an identifier of a target entity. To gather a reasonable number of results that does not unduly limit the documents in those results, users may employ broad keyword searching and then review each document to determine whether each document should be considered in class or out of class for the purposes at hand. However, taking patents and patent applications as an example, the potential corpus of documents, even if looking just to patents and patent applications filed in the United States, easily numbers in the thousands if not tens of thousands or more. Additionally, grouping the patents into groupings based on one or more shared technical fields, subject matters, and/or by similar entities may become cumbersome, especially when dealing with a large corpus. In light of this, an IP analysis platform that is configured to identify IP assets that may be determined to be similar to the IP portfolio of one or more target entities, one or more target publications, and/or one or more target products and/or services and generate multiple result sets of varying levels of granularity would be beneficial. Additionally, an interactive graphical element including a representation of the metrics associated with the IP assets may be desirable to accurately and efficiently visualize an analysis of the IP assets.

In some cases, a first entity may desire to determine growth expectations, and/or other financial information associated with a second entity that the first entity considers to be an investment interest. In some cases, the second entity may be a privately owned company that is not required to disclose particular financial information that the first entity may require in order to determine whether or not the second entity is a worthwhile investment. However, there may be other types of data that the second entity may disclose publicly, such as IP asset data (e.g., patent data, patent application data, trademark data, copyright data, etc.), that may be usable to impute the financial information based on other financial information. In this way, the IP analysis platform disclosed herein may determine growth expectation and/or other financial information associated with a particular entity based on the IP assets owned and/or otherwise assigned to the particular entity.

In some cases, the IP analysis platform may generate a financial metric associated with one or more entities that provide publicly available market data. For example, these entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending. In some examples, the financial metric may be a composite metric for each individual entity that combines one or more of the market data. In some cases, a machine learning algorithm may generate the financial metric based in part on which market data is most relevant, accurate, and/or reliable. In some cases, one or more computer models of the IP analysis platform may parse the publicly available market data to identify relevant market data and input the relevant market data into a machine learning algorithm, and receiving one or more outputs from the machine learning algorithm that may include the financial metric.

In some cases, the IP analysis platform may associate the financial metric associated with each of the entities with the IP assets that are associated with each of the entities. For example, some or all of the entities (e.g., publicly traded companies) may own and/or otherwise be assignees to IP assets that are publicly available. The IP analysis platform may associate the financial metric for a particular entity with that entities IP assets, thereby “labeling” each IP asset with an individual financial metric. In some examples, the IP analysis platform may also categorize each IP asset into a particular technology category and/or subcategory. By way of example, a technology category may include “automotive” and the subcategories may include “ion batteries,” “charging accessories,” “lidar,” “suspension,” “body,” etc..

In some examples, once each IP asset for each entity (e.g., publicly traded company) is associated with a financial metric and/or a technology area, the IP analysis platform may identify other IP assets assigned to other entities that may not be publicly traded companies (e.g., private companies). For example, the IP assets of the other entities (e.g., private companies) may be publicly available to be parsed and analyzed by the IP analysis platform. In one example, the IP analysis platform may identify IP assets (or a single IP asset) associated with a particular entity that is not publicly traded and therefore, does not disclose financial information. In some examples, the IP analysis platform may identify a technology area and/or other data associated with the IP assets associated with the particular entity.

In some cases, once the technology area and/or other data associated with the IP assets associated with the particular entity is determined, the IP analysis platform may identify other IP assets within the same technology area and/or subcategory of the technology area that are associated with publicly traded entities. For example, the IP analysis platform may determine that the IP assets associated with the particular entity may be categorized as “automotive” and further categorized into “ion battery” and “lidar” subcategories. The IP analysis platform may then identify other IP assets that are also categorized as “automotive” and further categorized into “ion battery” and “lidar” subcategories that are associated with the publicly traded entities and that are associated with financial metrics. Once the financial metrics associated with the IP assets of the publicly traded entities are identified, the IP analysis platform may determine that the financial metric may also be associated with the IP assets of the particular entity (e.g., private company) in response to the IP assets of the particular entity and the IP assets of the public entity being in the same technology area and/or subcategory.

In some examples, the IP analysis platform may be configured to produce a qualitative analysis of IP assets using asset data obtained from a number of different sources in varying areas of interest, such as, for example, target technical fields, targeted publications, targeted products, and/or targeted entity portfolios. The platform may include a value modeling component that may include various sub-components, such as, a coverage component, an opportunity component, an exposure component, and a data store. In some examples, the coverage component may include various sub-components, such as, a geographic distribution component, an expiration component, a comprehensive breadth score component, a diversity component, a revenue alignment component and/or an invalidity component. In some cases, the opportunity component may include various sub-components, such as, a filing velocity component, a predictive analytics component, and/or a precedence component. In some examples, the exposure component may include various sub-component, such as, a litigation campaign component and/or an alignment to exposure component. In some examples, the datastore may be a secure datastore accessible by the system and utilized to securely store user account data including a project library, an IP asset library including one or more IP assets, and/or historical data. The IP analysis platform may be accessible to users via one or more user interfaces that may be configured to display information associated with analysis report(s) associated with a user account of the user and/or one or more user account(s) associated with the user account. Additionally, or alternatively, the user interface(s) may be configured to receive user input.

The IP analysis platform may be configured to display a user interface for presenting information associated with the analysis report(s) and/or analysis associated with the user account. For example, the user interface may include selectable portions that when selected, may present information associated with the value modeling component. Additionally, or alternatively, the IP analysis platform may be configured to cause the user interface to present information associated with the value modeling component using different views. Additionally, or alternatively, the user interface(s) may include one or more information windows for presenting information associated with the analysis report(s) associated with the user account.

When a user accesses the IP analysis platform using a user account, the user interface may be caused to display one or more pages that present portions of the information associated with the value modeling component using information windows that are relevant to that page. Pages that may be accessed by a user account may include for example, comprehensive score page, an entity screener page, and/or the like. As mentioned above, each page presents information using information windows that are relevant to that page.

In some examples, the comprehensive score page may include a number of views that may be presented in response to selection of a corresponding view selection element. For example, the comprehensive score page may display a comprehensive score indicating an IP coverage associated with the IP asset portfolio and/or a subset of the IP asset portfolio. The comprehensive score page may also display a coverage score (e.g., coverage metric), an opportunity score (e.g., an opportunity metric), and an exposure metric (e.g., an exposure metric) that are used by the IP analysis platform to generate the comprehensive score. The comprehensive score page may also include other information (e.g., company name, location, website, revenue data, employee data, and/or summary data) associated with an entity in which the analysis report is based on.

In some examples, the entity screener page may include a number of views that may be presented in response to selection of a corresponding view selection element. For example, the entity screener page may display one or more entities (e.g., companies) associated with a technology area (e.g., automotive, music and video, smartphones, business/personal, wearable technology, tablets, etc.) as well as one or more metrics generated by the sub-components of the IP analysis platform. For example, the entity screener page may display, for each IP asset(s) (e.g., IP asset portfolio) associated with each of the entities, a comprehensive breadth score, a coverage score, an opportunity score, an exposure score, a filing velocity score, an imputed research and development value, an imputed revenue value, an imputed market cap, and/or an imputed P/E value. In some cases, the screener page may enable to input one or more criteria (e.g., screener criteria) that may change the results displayed on the screener page. For example, the input criteria may include setting values (e.g., “total score greater than 70,” “annual revenue greater than $600 million,” etc.) for the metrics that cause the screener page to display the entities that satisfy the input criteria.

As mentioned above, the IP analysis platform may include a datastore. In some examples, the datastore may include data corresponding to user accounts, projects, IP assets, historical data, saved results from previous interactions the user account has made with the IP analysis platform, and/or market data. The analysis report(s) may include, for example, coverage metric results, opportunity metric results, exposure metric results, seeded search queries, similarity results, comprehensive breadth score results, revenue alignment results, filing velocity results, financial metric results, and/or litigation campaign results. The analysis report(s) may be stored with respect to the user account(s). The IP asset(s) may be stored with respect to an IP asset library. In some examples, the IP asset library may include data associated with IP assets and/or related to a corresponding IP asset, such as, for example, licensing data, and/or standard essential patent data. The historical data may be stored with respect to the user account(s) and/or independently in the data store(s). In some examples, the historical data may include historical data associated with an entity, a publication, an IP asset, and/or a user account. For example, the historical data may include data specific to mergers and acquisitions associated with a particular entity and/or IP asset. The market data may include market data associated with an entity, an IP asset, a technological area, a product and/or service, and/or standardized market data, and/or any other non-IP related data of the like.

In some examples, a user interface generation component may be configured to generate user interface element(s) and/or user interface pages described above using data received from other components utilized by the system. In some examples, the user interface generation component may be communicatively coupled to the other components stored thereon the computer-readable media. In some examples, the user interface generation component may generate user interfaces configured to present information associated with analysis reports associated with a user account. Additionally, or alternatively, the user interface generation component may generate user interfaces including confidential information and may be configured to be accessible by only users with predetermined qualifications. For example, the user interface generation component may cause only a portion of information to be displayed based on the type of account that is accessing the system. For example, when a user accesses the system, the system may determine that the account type of the account that the user has utilized to access the system may be one of, for example, a client user account and/or an administrative user account. In some examples, the user interface generation component may generate interactive graphical elements and/or dynamic animation sequences associated with the interactive graphical elements.

Take for example, a user accessing the IP analysis platform to interact with, conduct research, and/or create a new analysis report. The value modeling component may be configured to receive data representing an analysis report. Additionally, or alternatively, the value modeling component may be configured to receive data representing a research query that is unassociated with an analysis. It should be appreciated that the operations described herein may be executed in association with and/or standalone from analysis reports. The analysis report may be created by and associated with a user account and/or one or more user accounts that are associated with the user account. The analysis reports may be stored in association with the user account data in the secure datastore. In some examples, the analysis reports may be utilized to organize and/or separate searches, identified similar IP assets and/or entities.

As mentioned above, the IP analysis platform may include a value modeling component that includes sub-components, such as, a coverage component utilized to determine an overall coverage and/or identify gaps in coverage, an opportunity component utilized to determine a potential market opportunity, an exposure component utilized to determine a potential exposure associated with the IP assets, and/or a financial modeling component configured to generate financial metrics associated with entities that own and/or otherwise are assignees of IP assets. In some examples, each of the coverage component, the opportunity component, and the exposure component may include one or more sub-components.

For example, the coverage component may include various sub-components, such as, a geographic distribution component, an expiration component, a comprehensive breadth score component, a diversity component, a revenue alignment component and/or an invalidity component. In some examples, the coverage component may utilize the one or more sub-components to make determinations and/or generate data to be displayed on the user interface. For example, each of the sub-components may generate a metric to be utilized by the coverage component to generate a coverage metric. In some examples, the coverage metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The coverage metric may indicate a comprehensive score indicating an IP coverage associated with the IP asset portfolio and/or a subset of the IP asset portfolio.

In some examples, the geographic distribution component may make determinations and/or generate data to be displayed on the user interface. For example, a user may specify one or more target entities, one or more target publications, and/or one or more target products that the geographic distribution component may utilize to generate a geographic distribution search. In some examples, the geographic distribution component may be configured to identify one or more target entities utilizing data representing one or more target publications and/or one or more target products. The results of the geographic distribution search may include an identification of which countries and/or regions that individual IP assets of an IP asset portfolio are filed. In some examples, the geographic distribution component may determine which countries and/or regions the IP assets of the IP asset portfolio are filed for a given entity, market, and/or technology area. In some cases, the geographic distribution component may determine a metric based at least in part on which countries the IP assets are filed. For example, the geographic distribution component may determine a gross domestic product (GDP) value associated with each country and/or region in which an entity has filed IP assets. The geographic distribution component may generate a metric based on which countries and/or regions the IP assets are filed and the GDP of those respective countries and/or regions. In some cases, if a country that the IP assets are filed in have a higher GDP, the geographic distribution component may generate a positive metric. Additionally, and/or alternatively, if a country that the IP assets are filed in have a lower GDP, the geographic distribution component may generate a negative metric. In some examples, the metrics generated by the geographic distribution component may be used by the coverage component to generate a coverage metric.

In some examples, the expiration component may make determinations and/or generate data to be displayed on the user interface. For example, a user may specify one or more target entities, one or more target publications, and/or one or more target products that the expiration component may utilize to generate an expiration search. In some examples, the expiration component may be configured to identify one or more target entities utilizing data representing one or more target publications and/or one or more target products. The results of the expiration search may include determining a number and/or a breadth score associated with individual IP assets of an asset portfolio. In some cases, the expiration component may determine that a number of IP assets of an asset portfolio are about to expire and that a breadth score of these IP assets are high. In this case, the expiration component may generate a negative metric to be provide to the coverage component. Additionally, and/or alternatively, the expiration component may determine that a number of IP assets of an asset portfolio are about to expire and that a breadth score of these IP assets are low. In this case, the expiration component may generate a less negative metric to be provide to the coverage component.

In some examples, the comprehensive breadth score component may make determinations and/or generate data to be displayed on the user interface. For example, a user may specify one or more target entities, one or more target publications, and/or one or more target products that the comprehensive breadth score component may utilize to generate a comprehensive breadth search. In some examples, the comprehensive breadth score component may be configured to identify one or more target entities utilizing data representing one or more target publications and/or one or more target products. The results of the comprehensive breadth search may include a comprehensive breadth score for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The comprehensive breadth score for a group of IP assets (e.g., a portfolio of IP assets and/or a sub-set of the portfolio of IP assets) may be based on weighted breadth scores calculated for individual IP assets of the group of IP assets. For example, the comprehensive breadth score component may receive or otherwise identify a plurality of IP assets associated with an entity and calculate, for the individual IP assets of the plurality of IP assets, a breadth score based at least in part on a word count score and a commonness score for the respective portions of text included in the individual intellectual-property assets. In some cases, the word count score may be based on a word count associated with respective portions of text and word counts associated with portions of text from at least one other IP asset of the plurality of IP assets. In some cases, the commonness score may be based on a frequency in which words within the respective portion of text are found in the portions of text from at least one other IP asset. Once the breadth score is calculated for individual IP assets of the group of IP assets, the comprehensive breadth score component may calculate a weighted score for the individual IP assets based on multiplying the breadth score by a weight that is determined by the respective breadth scores for the individual IP assets. For example, the comprehensive breadth score component may assign a lower weight (e.g., 1) to an IP asset determined to have a low breadth score, a medium weight (e.g., 2) to an IP asset determined to have a medium breadth score, and a higher weight (e.g., 3) to an IP asset determined to have a high breadth score. Once the weighted breadth scores are determined, the comprehensive breadth score component may calculate a comprehensive score for the group of IP assets by calculating an average of the weighted scores of the individual IP assets. In some examples, the comprehensive breadth score component may provide the comprehensive score for the group of IP assets to the coverage component to be used in calculating a coverage metric.

In some cases, the comprehensive breadth score component can calculate the comprehensive breadth score for a group of IP assets based on a market and/or technology area. In some examples, the comprehensive breadth score component can calculate the comprehensive breadth score over multiple periods of time such that a visualization of how the comprehensive breadth score for a group of IP assets has changed over time can be depicted. In some cases, the comprehensive breadth score for a group of IP assets may have changed due to a new IP asset that has been filed, a new IP asset that has granted, a, IP asset that has expired, a and IP asset that has been abandoned and/or a breadth score for an IP asset that has changed.

In some examples, the diversity component may make determinations and/or generate data to be displayed on the user interface. For example, a user may specify one or more target entities, one or more target publications, and/or one or more target products that the diversity component may utilize to generate a diversity search. In some examples, the diversity component may be configured to identify one or more target entities utilizing data representing one or more target publications and/or one or more target products. The results of the diversity search may include a metric indicating how diversified a group of IP assets are over a given market and/or technology area.

In some examples, the revenue alignment component may make determinations and/or generate data to be displayed on the user interface. For example, a user may specify one or more target entities, one or more target publications, and/or one or more target products that the revenue alignment component may utilize to generate a revenue alignment search. In some examples, the revenue alignment component may be configured to identify one or more target entities utilizing data representing one or more target publications and/or one or more target products. The results of the revenue alignment search may include a metric indicating how a group of IP assets associated with an entity and with a given market and/or technology area aligns with the revenue generated by that market and/or technology area for the entity. For example, the revenue alignment component may identify one or more market areas and/or technology areas associated with an entity accessing the IP analysis platform. The revenue alignment component may identify revenue streams of the entity that are associate with the one or more market areas and/or one or more technology areas and identify a number of IP assets that are associated with the entity as well as the one or more technology areas. In some cases, the revenue alignment component may determine a percentage of revenue generated in a market area and/or technology area of a total amount of revenue generated by the entity and may determine a percentage of IP assets directed to the one or more market areas and/or one or more technology areas from among a group of IP assets filed by the entity. The revenue alignment component may then generate an alignment metric based at least in part on the number of the IP assets associated with the one or more market areas and/or one or more technology areas and the one or more revenue streams associated with the one or more market areas and/or one or more technology areas. In some examples, the revenue alignment component may identify the market and/or technology areas by accessing a taxonomy of market sets and/or a taxonomy of technology areas provided by a third-party resource and/or stored on the database. In this way, the revenue alignment component may illustrate if an entity is revenue heavy (e.g., greater percentage of revenue generated than percentage of IP assets filed) or is more IP asset heavy (e.g., greater percentage of IP assets filed than percentage of revenue generated) for individual market areas and/or technology areas.

In some cases, the revenue alignment component may also generate a metric illustrating a revenue alignment for multiple other entities. For example, the revenue alignment component may determine a percentage of revenue generated in a market area and/or technology area of a total amount of revenue generated by a group of entities and may determine a percentage of IP assets directed to the one or more market areas and/or one or more technology areas from among a group of IP assets filed by the group of entities. In this way, the revenue alignment component may illustrate a comparison of a revenue alignment metric associated with the entity to a revenue alignment metric associated with multiple other entities generating revenue and filing IP assets in an individual market area and/or technology area.

In some examples, the invalidity component may make determinations and/or generate data to be displayed on the user interface. For example, a user may specify one or more target entities, one or more target publications, and/or one or more target products that the invalidity component may utilize to generate a geographic distribution search. In some examples, the invalidity component may be configured to identify one or more target entities utilizing data representing one or more target publications and/or one or more target products. The results of the invalidity search may include citation data associated with a group of IP assets and/or individual IP assets associated with an entity accessing the IP analysis platform. In some cases, the invalidity component may generate an invalidity metric indicating a likelihood that an IP asset may be considered to be invalid if it were to be challenged in a court of law. In some cases, the invalidity component may generate the invalidity metric based on a density of other IP assets cited during prosecution of the IP asset, a density of other IP assets in which the IP asset was cited during prosecution, and/or litigation data associated with the other IP assets (e.g., result of invalidity challenges of the other IP assets). In some cases, the invalidity metric may be utilized by other component and/or sub-components to impact other metrics, such as the comprehensive breadth score metric.

In some cases, the coverage component may utilize any metric generated by the various sub-components to generate a coverage metric associated with a group of IP assets associated with an entity and/or other entities. In some cases, other determinations may affect the coverage metric, such as, legal status of an IP asset (e.g., ownership of the IP asset), how a breadth scope of claims change during prosecution of an IP asset, etc.

In some cases, the opportunity component may include various sub-components, such as, a filing velocity component, a predictive analytics component, and/or a precedence component. In some examples, the opportunity component may utilize the one or more sub-components to make determinations and/or generate data to be displayed on the user interface. For example, each of the sub-components may generate a metric to be utilized by the opportunity component to generate an opportunity metric. In some examples, the opportunity metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The opportunity metric may indicate a potential market area and/or technology area opportunity associated with the IP asset portfolio and/or a subset of the IP asset portfolio.

In some examples, the filing velocity component may make determinations and/or generate data to be displayed on the user interface. For example, a user may specify one or more target entities, one or more target publications, and/or one or more target products that the filing velocity component may utilize to generate a filing velocity search. In some examples, the filing velocity component may be configured to identify one or more target entities utilizing data representing one or more target publications and/or one or more target products. The results of the filing velocity search may include a filing velocity metric indicating a percentile rank of an entity for filing of IP assets in a given market area and/or technology area. For example, the filing velocity component may identify a total amount of IP assets filed that are directed towards or otherwise associated with a given market area and/or technology area for a period of time (e.g., a year, five years, ten years, etc.) The filing velocity component may then identify a number of IP assets filed by individual entities, such as an entity accessing the IP analysis platform and associated entity competitors, during that time period directed towards or otherwise associated with the market area and/or the technology area. In some examples, the filing velocity component may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component to generate an opportunity metric. For example, a low percentile ranking (e.g., 10%, 20%, 30%) may indicate that an entity is underperforming with regard to a number of IP assets filed in a particular market area and/or technology area. Additionally, and/or alternatively, a high percentile ranking (e.g., 70%, 80%, 90%) may indicate that an entity is overperforming with regard to a number of IP assets filed in a particular market area and/or technology area.

In some examples, the filing velocity component may identify a total amount of IP assets filed that are directed towards or otherwise associated with an IP art unit for a period of time (e.g., a year, five years, ten years, etc.) The filing velocity component may then identify a number of IP assets filed by individual entities, such as an entity accessing the IP analysis platform and associated entity competitors, during that time period directed towards or otherwise associated with the IP art unit. In some examples, the filing velocity component may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component to generate an opportunity metric. For example, a low percentile ranking (e.g., 10%, 20%, 30%) may indicate that an entity is underperforming with regard to a number of IP assets filed in a particular IP art unit. Additionally, and/or alternatively, a high percentile ranking (e.g., 70%, 80%, 90%) may indicate that an entity is overperforming with regard to a number of IP assets filed in a particular IP art unit.

In some examples, the predictive analytics component may make determinations and/or generate data to be displayed on the user interface. For example, a user may specify one or more target entities, one or more target publications, and/or one or more target products that the predictive analytics component may utilize to generate a predictive analytics search. In some examples, the predictive analytics component may be configured to identify one or more target entities utilizing data representing one or more target publications and/or one or more target products. The results of the predictive analytics search may include a predicted comprehensive breadth score for a pending IP asset associated with an entity. For example, the predictive analytics component may determine an examiner and/or an art unit associated with at least one pending IP asset filed or otherwise associated with the entity. In some cases, the predictive analytics component may determine a comprehensive breadth score, as discussed herein, for at least one originally filed claim of an IP asset (e.g., application) previously examined by the examiner and/or previously filed in the art unit. The predictive analytics component may then determine a comprehensive breadth score for an issued version of the originally filed claim of the application and generate an examiner metric and/or an art unit metric based at least in part on a difference between the comprehensive breadth score of the originally filed claims and the comprehensive breadth score of the issued claims. In this way, the predictive analytics component may determine an effect that a particular examiner and/or art unit may have on a comprehensive breadth score of a potentially allowable claim. For example, the predictive analytics component may determine predicted breadth score for a pending IP asset based at least in part on the examiner metric and/or the art unit metric. In some cases, the predicted breadth score may be utilized by the opportunity component to generate the opportunity metric.

In some cases, the predictive analytics component may generate a predicted issue date for a pending IP asset associated with an entity based on an average length of prosecution associated with an examiner and/or an art unit. In some cases, the predicted issue date may be utilized by the opportunity component to generate the opportunity metric.

In some examples, the precedence component may make determinations and/or generate data to be displayed on the user interface. For example, a user may specify one or more target entities, one or more target publications, and/or one or more target products that the precedence component may utilize to generate a precedence search. In some examples, the precedence component may be configured to identify one or more target entities utilizing data representing one or more target publications and/or one or more target products. The results of the precedence search may include metric data indicating a historical precedence associated with an IP asset. For example, the precedence component may identify a particular market area and/or technology area associated with an IP asset and determine a number of similar IP assets filed within the identified market area and/or technology area. In some examples, if the number of other IP assets is low, then the precedence metric associated with the IP asset may be high. Additionally, and/or alternatively, if the number of other IP assets is high, then the precedence metric associated with the IP asset may be low. Once the precedence component determines a precedence metric, the precedence metric may be provided to the opportunity component and utilized to generate the opportunity metric.

In some examples, the exposure component may include various sub-component, such as, a litigation campaign component and/or an alignment to exposure component. In some examples, the exposure component may utilize the one or more sub-components to make determinations and/or generate data to be displayed on the user interface. For example, each of the sub-components may generate a metric to be utilized by the exposure component to generate an exposure metric. In some examples, the exposure metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The exposure metric may indicate a potential exposure and/or risk (e.g. potential risk of litigation) associated with a market area and/or technology area associated with the IP asset portfolio and/or a subset of the IP asset portfolio. In some examples, the exposure component may identify the levels of exposure associated with the result sets and/or IP assists associated with an entity, and may aggregate the data indicating the levels of exposure associated with the result sets and/or IP asset to determine an overall level of exposure for an entity. In some examples, the exposure assessment component may be utilized in combination with any of the components described above. Additionally, or alternatively, the exposure component may make determinations and/or generate data to be displayed on the user interface.

In some examples, the litigation campaign component may make determinations and/or generate data to be displayed on the user interface. For example, a user may specify one or more target entities, one or more target publications, and/or one or more target products that the litigation campaign component may utilize to generate a litigation campaign search. In some examples, the litigation campaign component may be configured to identify one or more target entities utilizing data representing one or more target publications and/or one or more target products. The results of the litigation campaign search may include data indicating a potential likelihood of litigation associated with a particular market area and/or technology area. For example, the litigation campaign component may identify a litigation campaign associated with a market area and/or technology area by determining that an entity has filed at least two cases associated with the market area and/or technology area within the same calendar year. Once the litigation campaign component determines that the at least two cases are part of a litigation campaign directed towards a particular market area and/or technology area, the litigation campaign component may determine a period of time since the most recent filing of a case included in the litigation campaign, a number of defendants associated with the litigation campaign, and/or a non-practicing entity (NPE) status of the litigation campaign (e.g., whether the entity associated with the litigation campaign is an NPE or a practicing entity). In some examples, the litigation campaign component may obtain litigation data (e.g., defendant information, plaintiff information, case filing information, etc.) from a third party resource and may store the data in the database. In some cases, the data generated by the litigation campaign component may be provided to the exposure component and utilized to generate an exposure metric.

In some examples, the alignment to exposure component may make determinations and/or generate data to be displayed on the user interface. For example, a user may specify one or more target entities, one or more target publications, and/or one or more target products that the alignment to exposure component may utilize to generate an alignment to exposure search. In some examples, the alignment to exposure component may be configured to identify one or more target entities utilizing data representing one or more target publications and/or one or more target products. The results of the alignment to exposure search may include metric data indicating a potential exposure metric associate with a group of IP assets associated with an entity with regard to potential litigation. For example, the alignment to exposure component may determine a market area and/or technology area associated with a group of IP assets filed and/or otherwise associated with an entity, such as an entity utilizing the IP analysis platform. The alignment to exposure component may then identifying a litigation history (e.g., past litigation and current litigation) associated with the technology area and/or market area. In some cases, if there is a large amount of litigation associated with the market area and/or technology area, the alignment to exposure component may determine that the group of IP assets are at a greater risk of litigation. Additionally, and/or alternatively, if there is a small amount of litigation associated with the market area and/or technology area, the alignment to exposure component may determine that the group of IP assets are at a lesser risk of litigation. In some cases, the data generated by the alignment to exposure component may be provided to the exposure component and utilized to generate an exposure metric.

In some cases, the financial modeling component may utilize any metric generated by the various sub-components discussed herein to generate a financial metric associated with IP asset(s)s associated with an entity and/or other entities and/or financial metrics associated with the entities themselves. For example, the financial modeling component may generate a financial metric associated with one or more entities that provide publicly available market data. For example, these entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending. In some examples, the financial metric may be a composite metric for each individual entity that combines one or more of the market data. In some cases, a machine learning algorithm may generate the financial metric based in part on which market data is most relevant, accurate, and/or reliable. In some cases, one or more computer models of the financial modeling component may parse the publicly available market data to identify relevant market data and input the relevant market data into a machine learning algorithm, and receiving one or more outputs from the machine learning algorithm that may include the financial metric.

In some cases, the financial modeling component may associate the financial metric associated with each of the entities with the IP assets that are associated with each of the entities. For example, some or all of the entities (e.g., publicly traded companies) may own and/or otherwise be assignees to IP assets that are publicly available. The financial modeling component may associate the financial metric for a particular entity with that entities IP assets, thereby “labeling” each IP asset with an individual financial metric. In some examples, the financial modeling component may also categorize each IP asset into a particular technology category and/or subcategory. By way of example, a technology category may include “automotive” and the subcategories may include “ion batteries,” “charging accessories,” “lidar,” “suspension,” “body,” etc..

In some examples, once each IP asset for each entity (e.g., publicly traded company) is associated with a financial metric and/or a technology area, the financial modeling component may identify other IP assets assigned to other entities that may not be publicly traded companies (e.g., private companies). For example, the IP assets of the other entities (e.g., private companies) may be publicly available to be parsed and analyzed by the financial modeling component. In one example, the financial modeling component may identify IP assets (or a single IP asset) associated with a particular entity that is not publicly traded and therefore, does not disclose financial information. In some examples, the financial modeling component may identify a technology area and/or other data associated with the IP assets associated with the particular entity.

In some cases, once the technology area and/or other data associated with the IP assets associated with the particular entity is determined, the financial modeling component may identify other IP assets within the same technology area and/or subcategory of the technology area that are associated with publicly traded entities. For example, the financial modeling component may determine that the IP assets associated with the particular entity may be categorized as “automotive” and further categorized into “ion battery” and “lidar” subcategories. The financial modeling component may then identify other IP assets that are also categorized as “automotive” and further categorized into “ion battery” and “lidar” subcategories that are associated with the publicly traded entities and that are associated with financial metrics. Once the financial metrics associated with the IP assets of the publicly traded entities are identified, the financial modeling component may determine that the financial metric may also be associated with the IP assets of the particular entity (e.g., private company) in response to the IP assets of the particular entity and the IP assets of the public entity being in the same technology area and/or subcategory.

In some examples, the value modeling component may utilize the coverage component, the opportunity component, the exposure component, the financial modeling component, and the respective metrics associated with each component to parse through massive amounts of computer generated data (e.g., market data) and generate imputed financial metrics associated with entities (e.g., private companies) that are otherwise unattainable.

In some examples, the value modeling component may be configured to receive data representing a seeded search query and may perform a search operation in a number of ways and provide data and/or metrics to the various other components and sub-components discussed herein. A seeded search query may include one or more instances of target data as described in more detail below. In some examples, the seeded search query may indicate an identification of one or more target entities. Additionally, or alternatively, the seeded search query may indicate an identification of one or more target publications, such as, for example, an IP asset. Additionally, or alternatively, the seeded search query may indicate an identification of one or more target products and/or services. In some examples, the IP analysis platform may be configured to receive additional data associated with the seeded search query. For example, the value modeling component may be configured to receive additional data via one or more actionable elements included on a graphical user interface (GUI) presented on a computing device and accessible to a user account. Additionally, or alternatively, the value modeling component may be configured to utilize the data representing a seeded search query to make various identifications and determinations associated with IP assets and/or entities, among other things.

In some examples, the seeded search query may indicate the identification of the one or more target entities, and the value modeling component may utilize the data to identify IP assets that are associated with the target entity. In some examples, the value modeling component may access one or more database(s) including a listing of all of the available IP assets associated with the target entity (e.g., an IP asset portfolio). Additionally, or alternatively, the value modeling component may generate a result set including IP assets having an assignee associated with the entity.

Additionally, or alternatively, the seeded search query may indicate the identification of the one or more target publications and may utilize the data representing the seeded search query to identify IP assets (or IP asset portfolios) that are determined to be similar to the target publication. The value modeling component may identify similar IP assets using various techniques. For example, the value modeling component may generate a vector representation of the target publication and use the vector representation to identify IP assets having similar vector representations. Techniques to generate vectors representing IP assets may include vectorization techniques such as Doc2Vec, or other similar techniques. Additionally, or alternatively, techniques to generate vectors representing IP assets may include a method that takes a document, such as an IP asset, and turns it into a vector form as a list of floating-point numbers based at least in part on the document's text contents. This vector form may be called an embedding. This embedding may be used to calculate distance, and therefore similarity, between documents.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

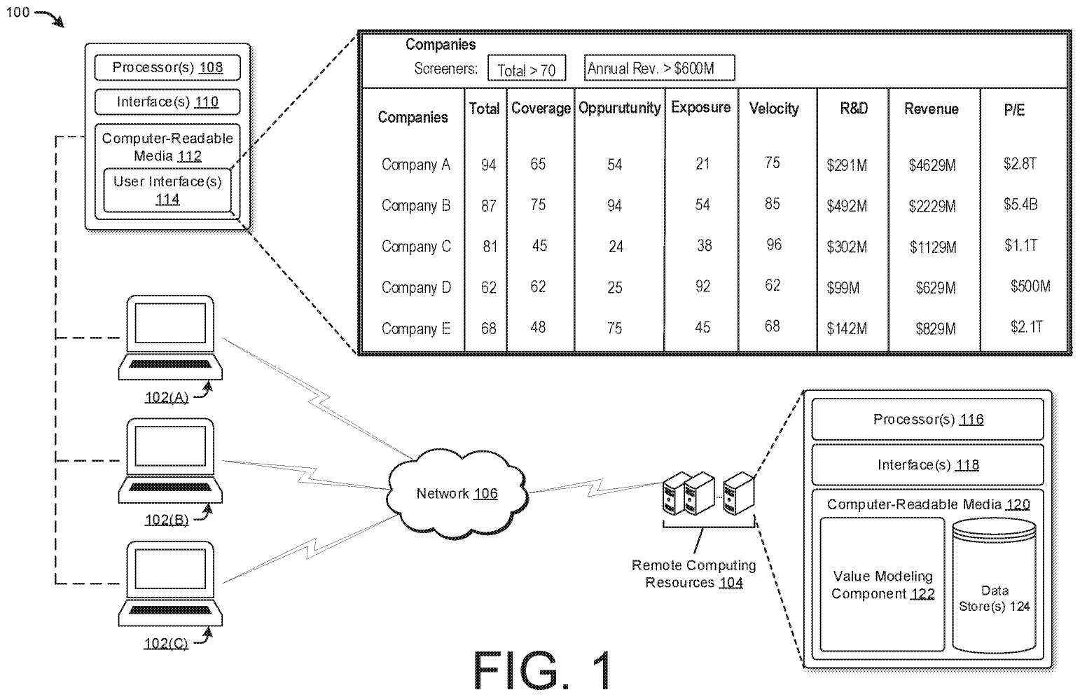

FIG. 1 illustrates a schematic diagram of an example environment 100 for an IP analysis platform architecture. The architecture 100 may include, for example, one or more user devices 102(a)-(c), also described herein as electronic devices 102(a)-(c), and/or a remote computing resources 104 associated with the IP analysis platform. Some or all of the devices and systems may be configured to communicate with each other via a network 106.

The electronic devices 102 may include components such as, for example, one or more processors 108, one or more network interfaces 110, and/or computer-readable media 112. The computer-readable media 112 may include components such as, for example, one or more user interfaces 114. As shown in FIG. 1, the electronic devices 102 may include, for example, a computing device, a mobile phone, a tablet, a laptop, and/or one or more servers. The components of the electronic device 102 will be described below by way of example. It should be understood that the example provided herein is illustrative and should not be considered the exclusive example of the components of the electronic device 102.

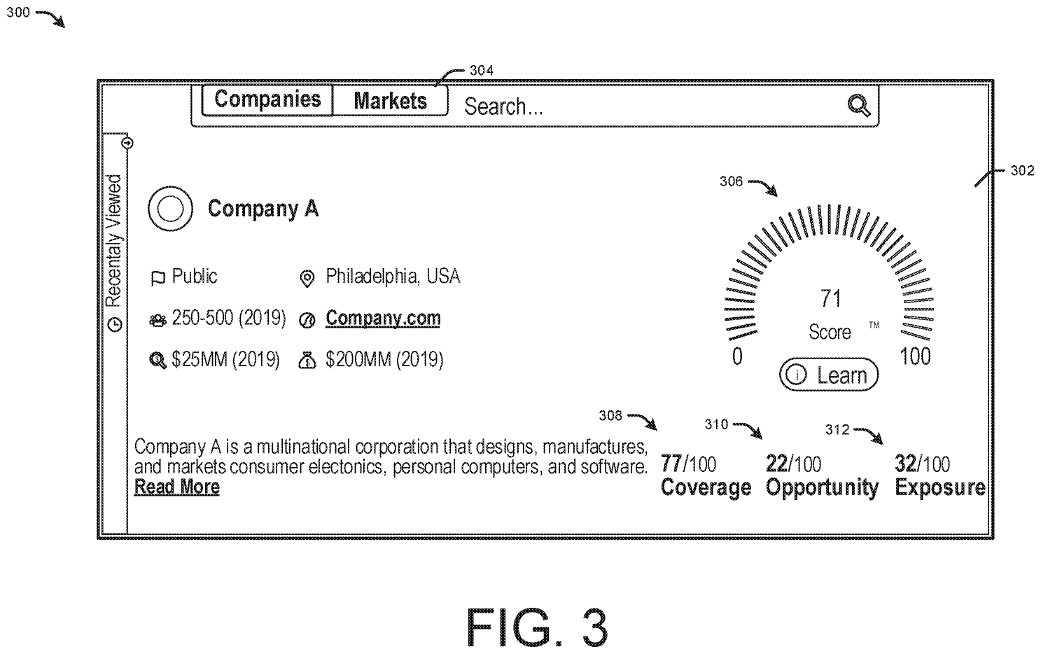

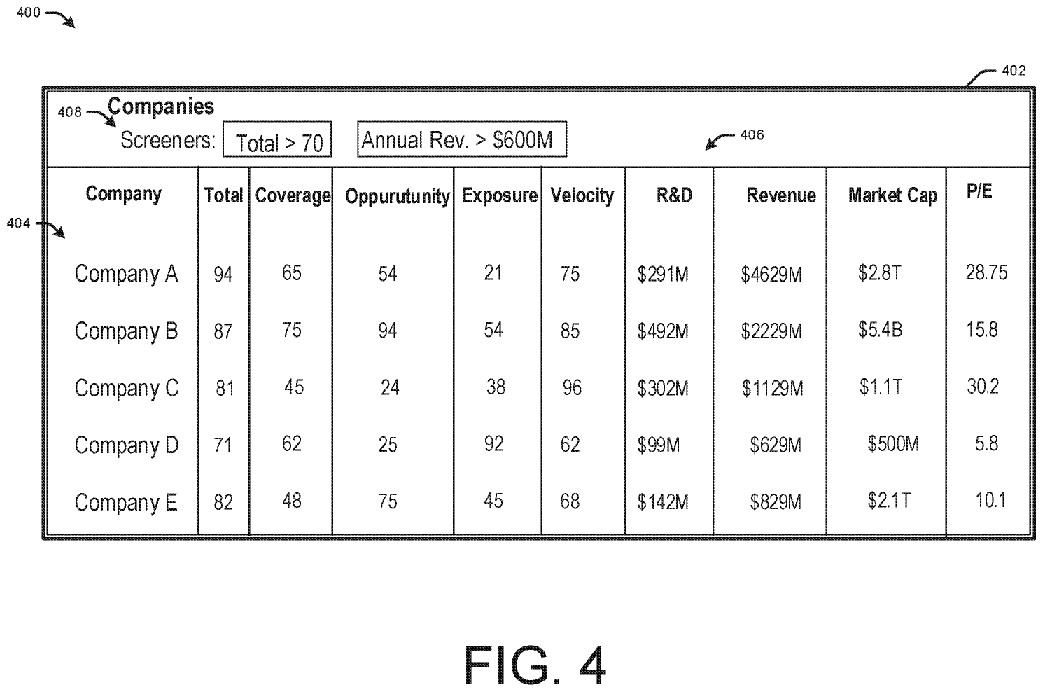

By way of example, the user interface(s) 114 may include one or more of the user interfaces described elsewhere herein, such as the user interfaces described with respect to FIGS. 3 and 4, corresponding to a comprehensive score user interface and an entity screener user interface. It should be understood that while the user interface(s) 114 are depicted as being a component of the computer-readable media 112 of the electronic devices 102(a)-(c), the user interface(s) 114 may additionally or alternatively be associated with the remote computing resources 104. The user interface(s) 114 may be configured to display information associated with the IP analysis platform and to receive user input associated with the IP analysis platform.

The remote computing resources 104 may include one or more components such as, for example, one or more processors 116, one or more network interfaces 118, and/or computer-readable media 120. The computer-readable media 120 may include one or more components, such as, for example, a value modeling component 122 and/or one or more data store(s) 124. The value modeling component 122 may be configured to receive user input data as described herein for indicating target data representing at least one of an entity, publication, and/or product utilized to generate seeded search queries that utilize the target data to determine a representative entity and return results including IP assets associated with the representative entity and/or one or more entities that have IP assets that are determined to be similar to the IP assets of the representative entity. The value modeling component 122 may also be configured to generate vector representations of the entities and/or IP assets such that the value modeling component 122 may rank and/or otherwise analyze the results from the search query by utilizing vector representations. The value modeling component 122 may also be configured to utilize the vector representations of the entities and/or the IP assets associated with the entities to generate result sets including comprehensive breadth scores, revenue alignment metrics, IP asset filing metrics, financial metrics, and/or litigation campaign metrics associated with the entities, technical fields, products or technologies of interest, IP assets associated with particular market areas and/or technical areas, etc. The value modeling component 122 may also be configured to generate an interactive graphical element, that may be configured to respond to various user inputs representing manipulations to the interactive graphical element, for presenting a spatial representation of the one or more metrics included in a selected result set.

The data store(s) 124 of the remote computing resources 104 may include data corresponding to user accounts, analysis reports, historical data, market data, and/or intellectual-property assets The analysis reports may include, for example, seeded search queries, similar entity and/or publication results, metric results, and/or the spatial representation of the metric results. The analysis reports may be stored with respect to the user account of the data store 124. The IP assets may be stored with respect to an IP asset library of the data store 124.

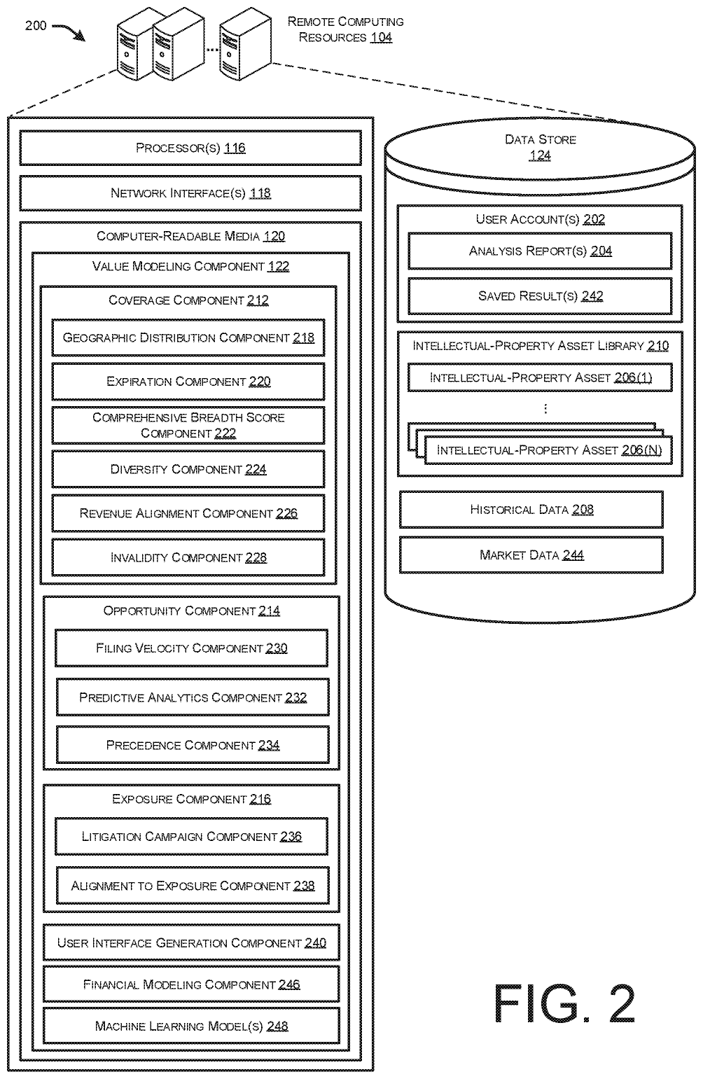

FIG. 2 illustrates a component diagram of an example environment 200. As shown in FIG. 2, several of the components of the remote computing resources 104 and/or the electronic devices 102 and the associated functionality of those components as described herein may be performed by one or more of the other systems and/or by the electronic devices 102. Additionally, or alternatively, some or all of the components and/or functionalities associated with the electronic devices 102 may be performed by the remote computing resource(s) 104.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 108 and/or 116, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 108 and/or 116 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 108 and/or 116 may possess its own local memory, which also may store program components, program data, and/or one or more operating systems.

The computer-readable media 112 and/or 120 may include volatile and nonvolatile memory, removable and non-removable media implemented in any method or technology for storage of information, such as computer-readable instructions, data structures, program component, or other data. Such computer-readable media 112 and/or 120 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 112 and/or 120 may be implemented as computer-readable storage media (“CRSM”), which may be any available physical media accessible by the processor(s) 108 and/or 116 to execute instructions stored on the computer-readable media 112 and/or 120. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as computer-readable media 112 and/or 120, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 110 and/or 118 may enable messages between the components and/or devices shown in system 100 and/or with one or more other remote systems, as well as other networked devices. Such network interface(s) 110 and/or 118 may include one or more network interface controllers (NICs) or other types of transceiver devices to send and receive messages over the network 106.

For instance, each of the network interface(s) 110 and/or 118 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 110 and/or 118 may include a wide area network (WAN) component to enable message over a wide area network.

In some instances, the remote computing resources 104 may be local to an environment associated with the electronic device(s) 102. For instance, the remote computing resources 104 may be located within the electronic device(s) 102. In some instances, some or all of the functionality of the remote computing resources 104 may be performed by the electronic device(s) 102. Also, while various components of the remote computing resources 104 have been labeled and named in this disclosure and each component has been described as being configured to cause the processor(s) 108 and/or 116 to perform certain operations, it should be understood that the described operations may be performed by some or all of the components and/or other components not specifically illustrated.

FIG. 2 illustrates a component diagram of example components 100 of a remote computing resource 104 for the IP analysis platform. The remote computing resource 104 may include one or more components such as, for example, one or more processor(s) 116, one or more network interfaces 118, and/or computer-readable media 120. The computer-readable media may include one or more components, such as, for example, a value modeling component 122 and/or one or more data stores 124. Some or all of the components and functionalities may be configured to communicate with each other.

The data store(s) 124 may include data corresponding to user account(s) 202, analysis report(s) 204, intellectual-property (IP) asset(s) 206(1)-(N), historical data 208, saved result(s) 242 from previous interactions the user account has made with the IP analysis platform, and/or market data 244. The analysis report(s) 204 may include, for example, seeded search queries, similarity results, metric results, and/or spatial representations of metrics. The analysis report(s) 204 may be stored with respect to the user account(s) 202. Additionally, or alternatively, the saved result(s) 242 may include, for example, seeded search queries, similarity results, metric results, and/or spatial representations of metric. The IP asset(s) 206(1)-(N) may be stored with respect to an IP asset library 210. In some examples, the IP asset library 210 may include data associated with IP assets and/or related to a corresponding IP asset, such as, for example, licensing data, and/or standard essential patent data. The historical data 208 may be stored with respect to the user account(s) 202 and/or independently in the data store(s) 124. In some examples, the historical data 208 may include historical data associated with an entity, a publication, an IP asset 206, and/or a user account 202. For example, the historical data 208 may include data specific to mergers and acquisitions associated with a particular entity and/or IP asset 206. The market data 244 may include market data associated with an entity, an IP asset 206, a technological area, a product and/or service, standardized market data, revenue data, and/or any other non-IP related data of the like. In some examples, the market data 244 may be obtained from a third-party resource. For example, the entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending.

As mentioned with respect to FIG. 1, the value modeling component 122 may be configured to receive user input data as described herein for indicating screener criteria used by the value modeling component 122 to determine target data representing at least one of an entity, publication, and/or product utilized to generate seeded search queries that utilize the target data to determine a representative entity and return results including one or more IP assets associated with the representative entity, one or more entities that have IP assets that are determined to be similar to the IP assets of the representative entity, market area and/or technology areas associated with the IP assets of the representative entity, revenue data associated with the market area and/or technology areas of the representative entity, revenue data associated with one or more entities that have IP assets that are determined to be similar to the IP assets of the representative entity, and/or litigation data associated with market area and/or technology areas associated with the IP assets of the representative entity. The value modeling component 122 may also be configured to generate vector representations of the entities and/or IP assets such that the value modeling component 122 may rank the results from the search query by utilizing vector representations. The value modeling component 122 may also be configured to utilize the vector representations of the entities to generate result sets including metrics of selected entities associated with technical fields, IP assets, products or technologies of interest, etc. The value modeling component 122 may also be configured to generate an interactive graphical element, that may be configured to respond to various user inputs representing manipulations to the interactive graphical element, for presenting a spatial representation of the one or more metrics included in a selected result set. The value modeling component 122 may include one or more components, such as, a coverage component 212 utilized to determine an overall coverage and/or identify gaps in coverage, an opportunity component 214 utilized to determine a potential market opportunity, an exposure component 216 utilized to determine a potential exposure associated with the IP assets, and/or a financial modeling component 246 configured to generate financial metrics associated with entities that own and/or otherwise are assignees of IP assets. In some examples, each of the coverage component 212, the opportunity component 214, and the exposure component 216 may include one or more sub-components.

For example, the coverage component 212 may include various sub-components, such as, a geographic distribution component 218, an expiration component 220, a comprehensive breadth score component 222, a diversity component 224, a revenue alignment component 226 and/or an invalidity component 228. In some examples, the coverage component 212 may utilize the one or more sub-components to make determinations and/or generate data to be displayed on the user interface. For example, each of the sub-components may generate a metric to be utilized by the coverage component 212 to generate a coverage metric. In some cases, the opportunity component 214 may include various sub-components, such as, a filing velocity component 230, a predictive analytics component, 232 and/or a precedence component 234. In some examples, the opportunity component 214 may utilize the one or more sub-components to make determinations and/or generate data to be displayed on the user interface. For example, each of the sub-components may generate a metric to be utilized by the opportunity component 214 to generate an opportunity metric. In some examples, the exposure component 216 may include various sub-component, such as, a litigation campaign component 236 and/or an alignment to exposure component 238. In some examples, the exposure component 216 may utilize the one or more sub-components to make determinations and/or generate data to be displayed on the user interface. For example, each of the sub-components may generate a metric to be utilized by the exposure component 216 to generate an exposure metric. Additionally, or alternatively, the value modeling component 122 may be configured to perform the operations described below with respect to the one or more components.

In some examples, the geographic distribution component 218 may make determinations and/or generate data to be displayed on the user interface. For example, a user may specify one or more target entities, one or more target publications, and/or one or more target products that the geographic distribution component 218 may utilize to generate a geographic distribution search. In some examples, the geographic distribution component 218 may be configured to identify one or more target entities utilizing data representing one or more target publications and/or one or more target products. The results of the geographic distribution search may include an identification of which countries and/or regions that individual IP assets of an IP asset portfolio are filed. In some examples, the geographic distribution component 218 may determine which countries and/or regions the IP assets of the IP asset portfolio are filed for a given entity, market, and/or technology area. In some cases, the geographic distribution component 218 may determine a metric based at least in part on which countries the IP assets are filed. For example, the geographic distribution component 218 may determine a gross domestic product (GDP) value associated with each country and/or region in which an entity has filed IP assets. The geographic distribution component 218 may generate a metric based on which countries and/or regions the IP assets are filed and the GDP of those respective countries and/or regions. In some cases, if a country that the IP assets are filed in have a higher GDP, the geographic distribution component 218 may generate a positive metric. Additionally, and/or alternatively, if a country that the IP assets are filed in have a lower GDP, the geographic distribution component 218 may generate a negative metric. In some examples, the metrics generated by the geographic distribution component 218 may be used by the coverage component 212 to generate a coverage metric.

In some examples, the expiration component 220 may make determinations and/or generate data to be displayed on the user interface. For example, a user may specify one or more target entities, one or more target publications, and/or one or more target products that the expiration component 220 may utilize to generate an expiration search. In some examples, the expiration component 220 may be configured to identify one or more target entities utilizing data representing one or more target publications and/or one or more target products. The results of the expiration search may include determining a number and/or a breadth score associated with individual IP assets of an asset portfolio. In some cases, the expiration component 220 may determine that a number of IP assets of an asset portfolio are about to expire and that a breadth score of these IP assets are high. In this case, the expiration component 220 may generate a negative metric to be provide to the coverage component 212. Additionally, and/or alternatively, the expiration component 220 may determine that a number of IP assets of an asset portfolio are about to expire and that a breadth score of these IP assets are low. In this case, the expiration component 220 may generate a less negative metric to be provide to the coverage component 212.

In some examples, the comprehensive breadth score component 222 may make determinations and/or generate data to be displayed on the user interface. For example, a user may specify one or more target entities, one or more target publications, and/or one or more target products that the comprehensive breadth score component 222 may utilize to generate a comprehensive breadth search. In some examples, the comprehensive breadth score component 222 may be configured to identify one or more target entities utilizing data representing one or more target publications and/or one or more target products. The results of the comprehensive breadth search may include a comprehensive breadth score for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The comprehensive breadth score for a group of IP assets (e.g., a portfolio of IP assets and/or a sub-set of the portfolio of IP assets) may be based on weighted breadth scores calculated for individual IP assets of the group of IP assets. For example, the comprehensive breadth score component 222 may receive or otherwise identify a plurality of IP assets associated with an entity and calculate, for the individual IP assets of the plurality of IP assets, a breadth score based at least in part on a word count score and a commonness score for the respective portions of text included in the individual intellectual-property assets. In some cases, the word count score may be based on a word count associated with respective portions of text and word counts associated with portions of text from at least one other IP asset of the plurality of IP assets. In some cases, the commonness score may be based on a frequency in which words within the respective portion of text are found in the portions of text from at least one other IP asset. Once the breadth score is calculated for individual IP assets of the group of IP assets, the comprehensive breadth score component 222 may calculate a weighted score for the individual IP assets based on multiplying the breadth score by a weight that is determined by the respective breadth scores for the individual IP assets. For example, the comprehensive breadth score component 222 may assign a lower weight (e.g., 1) to an IP asset determined to have a low breadth score, a medium weight (e.g., 2) to an IP asset determined to have a medium breadth score, and a higher weight (e.g., 3) to an IP asset determined to have a high breadth score. Once the weighted breadth scores are determined, the comprehensive breadth score component 222 may calculate a comprehensive score for the group of IP assets by calculating an average of the weighted scores of the individual IP assets. In some examples, the comprehensive breadth score component 222 may provide the comprehensive score for the group of IP assets to the coverage component 212 to be used in calculating a coverage metric.

In some cases, the comprehensive breadth score component 222 can calculate the comprehensive breadth score for a group of IP assets based on a market and/or technology area. In some examples, the comprehensive breadth score component 222 can calculate the comprehensive breadth score over multiple periods of time such that a visualization of how the comprehensive breadth score for a group of IP assets has changed over time can be depicted. In some cases, the comprehensive breadth score for a group of IP assets may have changed due to a new IP asset that has been filed, a new IP asset that has granted, a, IP asset that has expired, a and IP asset that has been abandoned and/or a breadth score for an IP asset that has changed.

In some examples, the diversity component 224 may make determinations and/or generate data to be displayed on the user interface. For example, a user may specify one or more target entities, one or more target publications, and/or one or more target products that the diversity component 224 may utilize to generate a diversity search. In some examples, the diversity component 224 may be configured to identify one or more target entities utilizing data representing one or more target publications and/or one or more target products. The results of the diversity search may include a metric indicating how diversified a group of IP assets are over a given market and/or technology area.

In some examples, the revenue alignment component 226 may make determinations and/or generate data to be displayed on the user interface. For example, a user may specify one or more target entities, one or more target publications, and/or one or more target products that the revenue alignment component 226 may utilize to generate a revenue alignment search. In some examples, the revenue alignment component 226 may be configured to identify one or more target entities utilizing data representing one or more target publications and/or one or more target products. The results of the revenue alignment search may include a metric indicating how a group of IP assets associated with an entity and with a given market and/or technology area aligns with the revenue generated by that market and/or technology area for the entity. For example, the revenue alignment component 226 may identify one or more market areas and/or technology areas associated with an entity accessing the IP analysis platform. The revenue alignment component 226 may identify revenue streams of the entity that are associate with the one or more market areas and/or one or more technology areas and identify a number of IP assets that are associated with the entity as well as the one or more technology areas. In some cases, the revenue alignment component 226 may determine a percentage of revenue generated in a market area and/or technology area of a total amount of revenue generated by the entity and may determine a percentage of IP assets directed to the one or more market areas and/or one or more technology areas from among a group of IP assets filed by the entity. The revenue alignment component 226 may then generate an alignment metric based at least in part on the number of the IP assets associated with the one or more market areas and/or one or more technology areas and the one or more revenue streams associated with the one or more market areas and/or one or more technology areas. In some examples, the revenue alignment component 226 may identify the market and/or technology areas by accessing a taxonomy of market sets and/or a taxonomy of technology areas provided by a third-party resource and/or stored on the database. In this way, the revenue alignment component 226 may illustrate if an entity is revenue heavy (e.g., greater percentage of revenue generated than percentage of IP assets filed) or is more IP asset heavy (e.g., greater percentage of IP assets filed than percentage of revenue generated) for individual market areas and/or technology areas.

In some cases, the revenue alignment component 226 may also generate a metric illustrating a revenue alignment for multiple other entities. For example, the revenue alignment component 226 may determine a percentage of revenue generated in a market area and/or technology area of a total amount of revenue generated by a group of entities and may determine a percentage of IP assets directed to the one or more market areas and/or one or more technology areas from among a group of IP assets filed by the group of entities. In this way, the revenue alignment component 226 may illustrate a comparison of a revenue alignment metric associated with the entity to a revenue alignment metric associated with multiple other entities generating revenue and filing IP assets in an individual market area and/or technology area.

In some examples, the invalidity component 228 may make determinations and/or generate data to be displayed on the user interface. For example, a user may specify one or more target entities, one or more target publications, and/or one or more target products that the invalidity component 228 may utilize to generate a geographic distribution search. In some examples, the invalidity component 228 may be configured to identify one or more target entities utilizing data representing one or more target publications and/or one or more target products. The results of the invalidity search may include citation data associated with a group of IP assets and/or individual IP assets associated with an entity accessing the IP analysis platform. In some cases, the invalidity component 228 may generate an invalidity metric indicating a likelihood that an IP asset may be considered to be invalid if it were to be challenged in a court of law. In some cases, the invalidity component 228 may generate the invalidity metric based on a density of other IP assets cited during prosecution of the IP asset, a density of other IP assets in which the IP asset was cited during prosecution, and/or litigation data associated with the other IP assets (e.g., result of invalidity challenges of the other IP assets). In some cases, the invalidity metric may be utilized by other component and/or sub-components to impact other metrics, such as the comprehensive breadth score metric.

In some cases, the coverage component 212 may utilize (e.g., aggregate) any metric generated by the various sub-components to generate a coverage metric associated with a group of IP assets associated with an entity and/or other entities. In some cases, other determinations may affect the coverage metric, such as, legal status of an IP asset (e.g., ownership of the IP asset), how a breadth scope of claims change during prosecution of an IP asset, etc.

In some examples, the filing velocity component 230 may make determinations and/or generate data to be displayed on the user interface. For example, a user may specify one or more target entities, one or more target publications, and/or one or more target products that the filing velocity component 230 may utilize to generate a filing velocity search. In some examples, the filing velocity component 230 may be configured to identify one or more target entities utilizing data representing one or more target publications and/or one or more target products. The results of the filing velocity search may include a filing velocity metric indicating a percentile rank of an entity for filing of IP assets in a given market area and/or technology area. For example, the filing velocity component 230 may identify a total amount of IP assets filed that are directed towards or otherwise associated with a given market area and/or technology area for a period of time (e.g., a year, five years, ten years, etc.) The filing velocity component 230 may then identify a number of IP assets filed by individual entities, such as an entity accessing the IP analysis platform and associated entity competitors, during that time period directed towards or otherwise associated with the market area and/or the technology area. In some examples, the filing velocity component 230 may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component 214 to generate an opportunity metric. For example, a low percentile ranking (e.g., 10%, 20%, 30%) may indicate that an entity is underperforming with regard to a number of IP assets filed in a particular market area and/or technology area. Additionally, and/or alternatively, a high percentile ranking (e.g., 70%, 80%, 90%) may indicate that an entity is overperforming with regard to a number of IP assets filed in a particular market area and/or technology area. In some examples, the filing velocity component 230 may determine a threshold percentile (e.g., 50%) in which the filing velocity component 230 may compare the percentile ranking of the entity (e.g., based on the number of IP assets filed by the entity) to in order to determine how the percentile ranking may affect the opportunity metric. For example, a percentile ranking of the entity being below the threshold percentile may indicate that an entity is underperforming with regard to a number of IP assets filed in a particular market area and/or technology area. Additionally, and/or alternatively, a percentile ranking of the entity being above the threshold percentile may indicate that an entity is overperforming with regard to a number of IP assets filed in a particular market area and/or technology area.

In some examples, the filing velocity component 230 may identify a total amount of IP assets filed that are directed towards or otherwise associated with an IP art unit for a period of time (e.g., a year, five years, ten years, etc.) The filing velocity component 230 may then identify a number of IP assets filed by individual entities, such as an entity accessing the IP analysis platform and associated entity competitors, during that time period directed towards or otherwise associated with the IP art unit. In some examples, the filing velocity component 230 may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component 214 to generate an opportunity metric. For example, a low percentile ranking (e.g., 10%, 20%, 30%) may indicate that an entity is underperforming with regard to a number of IP assets filed in a particular IP art unit. Additionally, and/or alternatively, a high percentile ranking (e.g., 70%, 80%, 90%) may indicate that an entity is overperforming with regard to a number of IP assets filed in a particular IP art unit.

In some examples, the predictive analytics component 232 may make determinations and/or generate data to be displayed on the user interface. For example, a user may specify one or more target entities, one or more target publications, and/or one or more target products that the predictive analytics component 232 may utilize to generate a predictive analytics search. In some examples, the predictive analytics component 232 may be configured to identify one or more target entities utilizing data representing one or more target publications and/or one or more target products. The results of the predictive analytics search may include a predicted comprehensive breadth score for a pending IP asset associated with an entity. For example, the predictive analytics component 232 may determine an examiner and/or an art unit associated with at least one pending IP asset filed or otherwise associated with the entity. In some cases, the predictive analytics component 232 may determine a comprehensive breadth score, as discussed herein, for at least one originally filed claim of an IP asset (e.g., application) previously examined by the examiner and/or previously filed in the art unit. The predictive analytics component 232 may then determine a comprehensive breadth score for an issued version of the originally filed claim of the application and generate an examiner metric and/or an art unit metric based at least in part on a difference between the comprehensive breadth score of the originally filed claims and the comprehensive breadth score of the issued claims. In this way, the predictive analytics component 232 may determine an effect that a particular examiner and/or art unit may have on a comprehensive breadth score of a potentially allowable claim. For example, the predictive analytics component 232 may determine predicted breadth score for a pending IP asset based at least in part on the examiner metric and/or the art unit metric. In some cases, the predicted breadth score may be utilized by the opportunity component 214 to generate the opportunity metric.

In some cases, the predictive analytics component 232 may generate a predicted issue date for a pending IP asset associated with an entity based on an average length of prosecution associated with an examiner and/or an art unit. In some cases, the predicted issue date may be utilized by the opportunity component 214 to generate the opportunity metric.

In some examples, the precedence component 234 may make determinations and/or generate data to be displayed on the user interface. For example, a user may specify one or more target entities, one or more target publications, and/or one or more target products that the precedence component 234 may utilize to generate a precedence search. In some examples, the precedence component 234 may be configured to identify one or more target entities utilizing data representing one or more target publications and/or one or more target products. The results of the precedence search may include metric data indicating a historical precedence associated with an IP asset. For example, the precedence component 234 may identify a particular market area and/or technology area associated with an IP asset and determine a number of similar IP assets filed within the identified market area and/or technology area. In some examples, if the number of other IP assets is low, then the precedence metric associated with the IP asset may be high. Additionally, and/or alternatively, if the number of other IP assets is high, then the precedence metric associated with the IP asset may be low. Once the precedence component 234 determines a precedence metric, the precedence metric may be provided to the opportunity component 214 and utilized to generate the opportunity metric.

In some cases, the opportunity component 214 may utilize (e.g., aggregate) any metric generated by the various sub-components to generate an opportunity metric associated with a group of IP assets associated with an entity and/or other entities.

In some examples, the litigation campaign component 236 may make determinations and/or generate data to be displayed on the user interface. For example, a user may specify one or more target entities, one or more target publications, and/or one or more target products that the litigation campaign component 236 may utilize to generate a litigation campaign search. In some examples, the litigation campaign component 236 may be configured to identify one or more target entities utilizing data representing one or more target publications and/or one or more target products. The results of the litigation campaign search may include data indicating a potential likelihood of litigation associated with a particular market area and/or technology area. For example, the litigation campaign component 236 may identify a litigation campaign associated with a market area and/or technology area by determining that an entity has filed at least two cases associated with the market area and/or technology area within the same calendar year. Once the litigation campaign component 236 determines that the at least two cases are part of a litigation campaign directed towards a particular market area and/or technology area, the litigation campaign component 236 may determine a period of time since the most recent filing of a case included in the litigation campaign, a number of defendants associated with the litigation campaign, and/or a non-practicing entity (NPE) status of the litigation campaign (e.g., whether the entity associated with the litigation campaign is an NPE or a practicing entity). In some examples, the litigation campaign component 236 may obtain litigation data (e.g., defendant information, plaintiff information, case filing information, etc.) from a third party resource and may store the data in the database. In some cases, the data generated by the litigation campaign component 236 may be provided to the exposure component 216 and utilized to generate an exposure metric.

In some examples, the alignment to exposure component 238 may make determinations and/or generate data to be displayed on the user interface. For example, a user may specify one or more target entities, one or more target publications, and/or one or more target products that the alignment to exposure component 238 may utilize to generate an alignment to exposure search. In some examples, the alignment to exposure component 238 may be configured to identify one or more target entities utilizing data representing one or more target publications and/or one or more target products. The results of the alignment to exposure search may include metric data indicating a potential exposure metric associate with a group of IP assets associated with an entity with regard to potential litigation. For example, the alignment to exposure component 238 may determine a market area and/or technology area associated with a group of IP assets filed and/or otherwise associated with an entity, such as an entity utilizing the IP analysis platform. The alignment to exposure component 238 may then identifying a litigation history (e.g., past litigation and current litigation) associated with the technology area and/or market area. In some cases, if there is a large amount of litigation associated with the market area and/or technology area, the alignment to exposure component 238 may determine that the group of IP assets are at a greater risk of litigation. Additionally, and/or alternatively, if there is a small amount of litigation associated with the market area and/or technology area, the alignment to exposure component 238 may determine that the group of IP assets are at a lesser risk of litigation. In some cases, the data generated by the alignment to exposure component 238 may be provided to the exposure component 238 and utilized to generate an exposure metric.

In some cases, the financial modeling component 246 may utilize any metric generated by the various sub-components discussed herein to generate a financial metric associated with IP asset(s)s associated with an entity and/or other entities and/or financial metrics associated with the entities themselves. For example, the financial modeling component 246 may generate a financial metric associated with one or more entities that provide publicly available market data. For example, these entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending. In some examples, the financial metric may be a composite metric for each individual entity that combines one or more of the market data. In some cases, a machine learning algorithm may generate the financial metric based in part on which market data is most relevant, accurate, and/or reliable. In some cases, one or more computer models of the financial modeling component 246 may parse the publicly available market data to identify relevant market data and input the relevant market data into a machine learning algorithm, and receiving one or more outputs from the machine learning algorithm that may include the financial metric.

In some cases, the financial modeling component 246 may associate the financial metric associated with each of the entities with the IP assets that are associated with each of the entities. For example, some or all of the entities (e.g., publicly traded companies) may own and/or otherwise be assignees to IP assets that are publicly available. The financial modeling component 246 may associate the financial metric for a particular entity with that entities IP assets, thereby “labeling” each IP asset with an individual financial metric. In some examples, the financial modeling component 246 may also categorize each IP asset into a particular technology category and/or subcategory. By way of example, a technology category may include “automotive” and the subcategories may include “ion batteries,” “charging accessories,” “lidar,” “suspension,” “body,” etc.

In some examples, once each IP asset for each entity (e.g., publicly traded company) is associated with a financial metric and/or a technology area, the financial modeling component 246 may identify other IP assets assigned to other entities that may not be publicly traded companies (e.g., private companies). For example, the IP assets of the other entities (e.g., private companies) may be publicly available to be parsed and analyzed by the financial modeling component 246. In one example, the financial modeling component 246 may identify IP assets (or a single IP asset) associated with a particular entity that is not publicly traded and therefore, does not disclose financial information. In some examples, the financial modeling component 246 may identify a technology area and/or other data associated with the IP assets associated with the particular entity.

In some cases, once the technology area and/or other data associated with the IP assets associated with the particular entity is determined, the financial modeling component 246 may identify other IP assets within the same technology area and/or subcategory of the technology area that are associated with publicly traded entities. For example, the financial modeling component 246 may determine that the IP assets associated with the particular entity may be categorized as “automotive” and further categorized into “ion battery” and “lidar” subcategories. The financial modeling component 246 may then identify other IP assets that are also categorized as “automotive” and further categorized into “ion battery” and “lidar” subcategories that are associated with the publicly traded entities and that are associated with financial metrics. Once the financial metrics associated with the IP assets of the publicly traded entities are identified, the financial modeling component 246 may determine that the financial metric may also be associated with the IP assets of the particular entity (e.g., private company) in response to the IP assets of the particular entity and the IP assets of the public entity being in the same technology area and/or subcategory. In some cases, the financial modeling component 246 may determine a similarity score between the IP assets of the particular entity and the IP assets of the public entity and determine whether the similarity score is greater than a threshold value (e.g., 80%, 90%, etc.). In cases where the similarity score is at and/or above the threshold value, the financial modeling component 246 may determine that the financial metric may also be associated with the IP assets of the particular entity (e.g., private company). In some examples, the financial modeling component 246 may determine percentages to apply to particular financial metrics that are associated with the subcategories based on how many of the IP assets of the particular entity are associated with the subcategory. For example, if the “ion battery” subcategory has a first associated financial metric and the “lidar” subcategory has a second associated financial metric, then the financial modeling component 246 may determine a percentage of the particular entities IP assets that are associated with each subcategory and apply the respective percentage to the corresponding financial metric, thereby generating a composite financial metric to be associated with the particular entity based on the varying types of IP assets.

In some cases, the financial modeling component 246 may determine an investment score associated with an entity based on the financial metrics associated with the entity. For example, after the financial metrics associated with the IP assets of the publicly traded entities are identified, the financial modeling component 246 may determine that the financial metric may also be associated with the IP assets of the particular entity (e.g., private company) and may determine an investment score for the particular entity based on the values of the financial metrics. For example, the investment score may include a value between 1 and 10 and may correlate to one or more financial metrics associated with the particular entity. By way of example, one of the financial metrics may include a high P/E value (e.g., 30) and be assigned an investment score based on the high P/E value. In some cases, a high P/E value may indicate a high earnings expectation and the investment score may therefore be high (e.g., 8). In other cases, the high P/E value may indicate an overpriced stock and the investment score may therefore be low (e.g., 3).

In some cases, a machine learning model(s) 248 may be utilized to generate one or more outputs for generating financial metrics. For example, generated financial metrics may be based on output of a trained machine learning model configured to analyze prior IP assessments and corresponding financial metric data to determine what information has impacted prior financial metric determinations. In some cases, the machine learning model(s) 248 may generate the financial metric based in part on which market data is most relevant, accurate, and/or reliable. In some cases, one or more computer models of the financial modeling component 246 may parse the publicly available market data to identify relevant market data and input the relevant market data into the machine learning model(s) 248, and receiving one or more outputs from the machine learning model(s) 248 that may include the financial metric. As described herein, machine learning model(s) 248 may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from data. In some cases, the neural network may be a trained network architecture that is end-to-end. In one example, the machine learned models may include segmenting and/or classifying extracted deep convolutional features of data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNeXt101, VGG, DenseNet, PointNet, CenterNet and the like. In some cases, the system may also apply Gaussian blurs, Bayes Functions, color analyzing or processing techniques and/or a combination thereof.

In some examples, the value modeling component 122 may utilize data received from and/or metrics generated by the coverage component 212, the opportunity component 214, the exposure component 216, the financial modeling component 246, and the respective metrics associated with each component to parse through massive amounts of computer generated data (e.g., market data) and generate imputed financial metrics associated with entities (e.g., private companies) that are otherwise unattainable.

In some examples, the value modeling component 122 may be configured to receive data representing a seeded search query and may perform a search operation in a number of ways and provide data and/or metrics to the various other components and sub-components discussed herein. A seeded search query may include one or more instances of target data. In some examples, the seeded search query may indicate an identification of one or more target entities. Additionally, or alternatively, the seeded search query may indicate an identification of one or more target publications, such as, for example, an IP asset. Additionally, or alternatively, the seeded search query may indicate an identification of one or more target products and/or services. In some examples, the IP analysis platform may be configured to receive additional data associated with the seeded search query. For example, the value modeling component 122 may be configured to receive additional data via one or more actionable elements included on a graphical user interface (GUI) presented on a computing device and accessible to a user account. Additionally, or alternatively, the value modeling component 122 may be configured to utilize the data representing a seeded search query to make various identifications and determinations associated with IP assets and/or entities, among other things.

The user interface generation component 240 may be configured to generate user interface element(s), window(s), page(s), and/or view(s) described below with respect to FIGS. 3 and 4 using data received from other components utilized by the IP analysis platform. In some examples, the user interface generation component 240 may be communicatively coupled to the other components stored thereon the computer-readable media 120. In some examples, the user interface generation component 240 may generate user interfaces configured to present information associated with user account(s) 202 data, analysis report(s) 204 data, and/or saved results 242. Additionally, or alternatively, the user interface generation component 240 may generate user interfaces including confidential information and may be configured to be accessible by only users with predetermined qualifications. For example, the user interface generation component 240 may cause only a portion of information to be displayed based on the type of account that is accessing the platform. For example, when a user accesses the system, the user interface generation component 240 may determine that the account type of the account that the user has utilized to access the system may be one of, for example, an internal user and/or an external user, and may only include a portion of the information to be displayed that is associated with that account type. In some examples, the user interface generation component 240 may generate notifications to send to the user accounts.

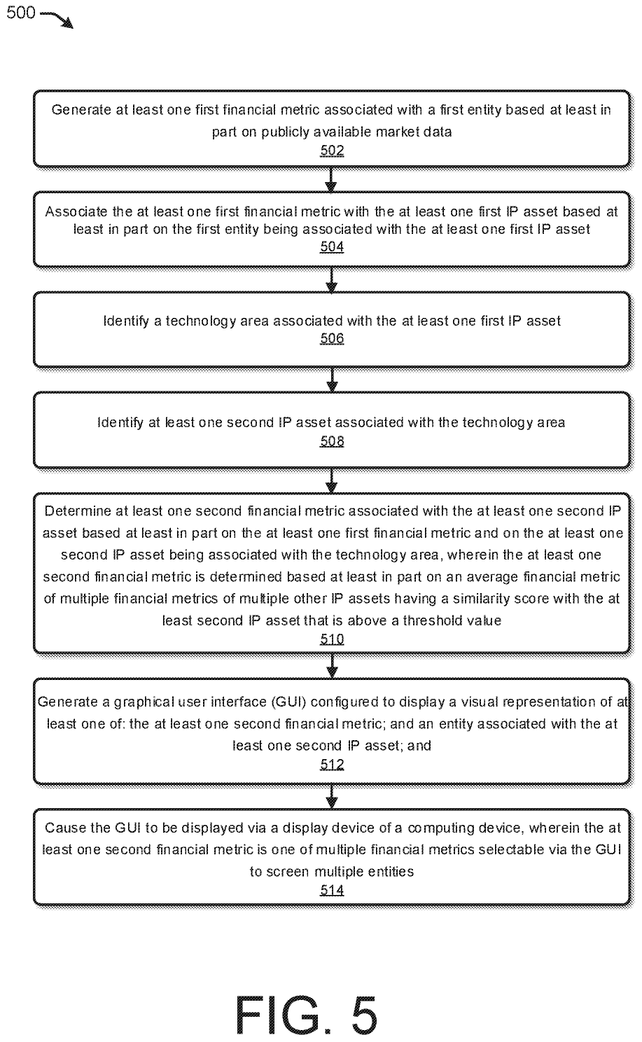

FIGS. 3 and 4 illustrate conceptual diagrams of example user interface(s) 300 and 400 that may receive user input and utilize the IP analysis platform to perform the various operations described above with respect to FIGS. 1 and 2 and/or the various operations described below with respect to FIGS. 5-7. The user interface(s) 300 and 400 may be generated by the user interface generation component 240 described with respect to FIG. 2 above. The user interface(s) 300 and 400 may be displayed on a display of an electronic device associated with a user account, such as the electronic device 102 as described with respect to FIG. 1 above. While example user interface(s) 300 and 400 are shown in FIGS. 3 and 4, the user interface(s) 300 and 400 are not intended to be construed as a limitation, and the user interface(s) 300 and 400 may be configured to present any of the data described herein.

FIG. 3 illustrates an example user interface 300 configured to present data associated with a user account representing a user created IP analysis reports(s) associated with a user account. The user interface 300 may include a comprehensive score page 302 and be displayed on a display of an electronic device associated with a user account, such as, for example, the electronic device 102 as described with respect to FIG. 1 above.

In some examples, the comprehensive score page 302 may include a number of views that may be presented in response to selection of a corresponding view selection element 304. For example, the comprehensive score page 302 may display a comprehensive score 306 indicating an IP coverage associated with the IP asset portfolio and/or a subset of the IP asset portfolio. The comprehensive score page 302 may also display a coverage score 308 (e.g., coverage metric), an opportunity score 310 (e.g., an opportunity metric), and an exposure metric 312 (e.g., an exposure metric) that are used by the IP analysis platform to generate the comprehensive score 306. The comprehensive score page 302 may also include other information (e.g., company name, location, website, revenue data, employee data, and/or summary data) associated with an entity in which the analysis report is based on.

FIG. 4 illustrates an example user interface 400 for displaying data associated with a user account representing information associated with screener criteria applied to one or more entities having IP assets. The user interface 400 may include a company screener page 402 and may be displayed on a display of an electronic device associated with a user account, such as, for example, the electronic device 102 as described with respect to FIG. 1 above.

In some examples, the entity screener page 402 may include a number of views that may be presented in response to selection of a corresponding view selection element. For example, the entity screener page 402 may display one or more entities 404 (e.g., companies) associated with a technology area (e.g., automotive, music and video, smartphones, business/personal, wearable technology, tablets, etc.) as well as one or more metrics 406 generated by the sub-components of the IP analysis platform. For example, the entity screener page 402 may display, for each IP asset(s) (e.g., IP asset portfolio) associated with each of the entities, a comprehensive breadth score, a coverage score, an opportunity score, an exposure score, a filing velocity score, an imputed research and development value, an imputed revenue value, an imputed market cap, and/or an imputed P/E value. In some cases, the screener page 402 may enable to input one or more criteria 408 (e.g., screener criteria) that may change the results displayed on the screener page 402. For example, the input criteria may include setting values (e.g., “total score greater than 70,” “annual revenue greater than $600 million,” etc.) for the metrics that cause the screener page to display the entities that satisfy the input criteria. In the example of FIG. 4, the criteria 408 are set for entities that have a total score above “70” and an annual revenue above “$600 M.” Thus, the entities 404 that are presented satisfy the criteria 408.

FIGS. 5-7 illustrate example processes associated with the IP analysis platform. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-4, although the processes may be implemented in a wide variety of other environments, architectures and systems.

FIG. 5 illustrates an example flow diagram of an example process 500 for utilizing a target entity having IP assets generate a user interface configured to present an analysis of the IP assets. The order in which the operations or steps are described is not intended to be construed as a limitation, and any number of the described operations may be combined in any order and/or in parallel to implement process 500. The operations described with respect to the process 500 are described as being performed by an electronic device and/or a remote computing resource associated with the IP analysis platform. However, it should be understood that some or all of these operations may be performed by some or all of components, devices, and/or systems described herein.

At block 502, the process 500 may include generating at least one first financial metric associated with a first entity based at least in part on publicly available market data. For example, the financial modeling component 246 may generate a financial metric associated with one or more entities that provide publicly available market data. For example, these entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending. In some examples, the financial metric may be a composite metric for each individual entity that combines one or more of the market data.

At block 504, the process 500 may include associating the at least one first financial metric with the at least one first IP asset based at least in part on the first entity being associated with the at least one first IP asset. For example, the financial modeling component 246 may associate the financial metric associated with each of the entities with the IP assets that are associated with each of the entities. For example, some or all of the entities (e.g., publicly traded companies) may own and/or otherwise be assignees to IP assets that are publicly available. The financial modeling component 246 may associate the financial metric for a particular entity with that entities IP assets, thereby “labeling” each IP asset with an individual financial metric. In some examples, the financial modeling component 246 may also categorize each IP asset into a particular technology category and/or subcategory. By way of example, a technology category may include “automotive” and the subcategories may include “ion batteries,” “charging accessories,” “lidar,” “suspension,” “body,” etc.

At block 506, the process 500 may include identifying a technology area associated with the at least one first IP asset. For example, the financial modeling component 246 may also categorize each IP asset into a particular technology category and/or subcategory. By way of example, a technology category may include “automotive” and the subcategories may include “ion batteries,” “charging accessories,” “lidar,” “suspension,” “body,” etc.

At block 508, the process 500 may include identifying at least one second IP asset associated with the technology area. For example, once each IP asset for each entity (e.g., publicly traded company) is associated with a financial metric and/or a technology area, the financial modeling component 246 may identify other IP assets assigned to other entities that may not be publicly traded companies (e.g., private companies). For example, the IP assets of the other entities (e.g., private companies) may be publicly available to be parsed and analyzed by the financial modeling component 246. In one example, the financial modeling component 246 may identify IP assets (or a single IP asset) associated with a particular entity that is not publicly traded and therefore, does not disclose financial information. In some examples, the financial modeling component 246 may identify a technology area and/or other data associated with the IP assets associated with the particular entity.

In some cases, once the technology area and/or other data associated with the IP assets associated with the particular entity is determined, the financial modeling component 246 may identify other IP assets within the same technology area and/or subcategory of the technology area that are associated with publicly traded entities. For example, the financial modeling component 246 may determine that the IP assets associated with the particular entity may be categorized as “automotive” and further categorized into “ion battery” and “lidar” subcategories. The financial modeling component 246 may then identify other IP assets that are also categorized as “automotive” and further categorized into “ion battery” and “lidar” subcategories that are associated with the publicly traded entities and that are associated with financial metrics.

At block 510, the process 500 may include determining at least one second financial metric associated with the at least one second IP asset based at least in part on the at least one first financial metric and on the at least one second IP asset being associated with the technology area, wherein the at least one second financial metric is determined based at least in part on an average financial metric of multiple financial metrics of multiple other IP assets having a similarity score with the at least second IP asset that is above a threshold value. For example, once the financial metrics associated with the IP assets of the publicly traded entities are identified, the financial modeling component 246 may determine that the financial metric may also be associated with the IP assets of the particular entity (e.g., private company) in response to the IP assets of the particular entity and the IP assets of the public entity being in the same technology area and/or subcategory. In some cases, the financial modeling component 246 may determine a similarity score between the IP assets of the particular entity and the IP assets of the public entity and determine whether the similarity score is greater than a threshold value (e.g., 80%, 90%, etc.). In cases where the similarity score is at and/or above the threshold value, the financial modeling component 246 may determine that the financial metric may also be associated with the IP assets of the particular entity (e.g., private company). In some examples, the financial modeling component 246 may determine percentages to apply to particular financial metrics that are associated with the subcategories based on how many of the IP assets of the particular entity are associated with the subcategory. For example, if the “ion battery” subcategory has a first associated financial metric and the “lidar” subcategory has a second associated financial metric, then the financial modeling component 246 may determine a percentage of the particular entities IP assets that are associated with each subcategory and apply the respective percentage to the corresponding financial metric, thereby generating a composite financial metric to be associated with the particular entity based on the varying types of IP assets.

At block 512, the process 500 may include generating a graphical user interface (GUI) configured to display a visual representation of at least one of the at least one second financial metric; and an entity associated with the at least one second IP asset. In some examples, the GUI may be configured to receive an input from the computing device. The computing device may be any of the electronic devices 102 and/or remote computing resources 104 described with respect to FIG. 1. Additionally, or alternatively, the GUI may include any of the example user interfaces 300 and 400 described with respect to FIGS. 3 and 4.

At block 514, the process 500 may include causing the GUI to be displayed via a display device of a computing device, wherein the at least one second financial metric is one of multiple financial metrics selectable via the GUI to screen multiple entities. For example, the screener page 402 may enable to input one or more criteria 408 (e.g., screener criteria) that may change the results displayed on the screener page 402. For example, the input criteria may include setting values (e.g., “total score greater than 70,” “annual revenue greater than $600 million,” etc.) for the metrics that cause the screener page to display the entities that satisfy the input criteria. In the example of FIG. 4, the criteria 408 are set for entities that have a total score above “70” and an annual revenue above “$600 M.” Thus, the entities 404 that are presented satisfy the criteria 408.

Additionally, or alternatively, at least one of the at least one first financial metric or the at least one second financial metric may comprise option expiration, historic volatility, implied volatility, moneyness, open interest, option price, P/E ratio, P/B ratio, put/call ratio, share price, stock exchange, strike price, intrinsic value, premium, volume, or research and development spending.

Additionally, or alternatively, the process 500 may include receiving the publicly available market data, parsing, via one or more computer models, the publicly available market data to identify relevant market data, inputting the relevant market data into a machine learning algorithm, and receiving one or more outputs from the machine learning algorithm, the one or more outputs being associated with the at least one second financial metric.

Additionally, or alternatively, the process 500 may include receiving additional relevant market data identified by the machine learning algorithm based at least in part on the relevant market data used as the input to the machine learning algorithm.

Additionally, or alternatively, the process 500 may include the multiple entities comprising private corporations in which publicly available financial information is not available.

Additionally, or alternatively, the process 500 may include determining a similarity score between the at least one first IP asset and the at least one second IP asset, and determining the at least one second financial metric associated with the at least one second IP asset based at least in part on the similarity score being above a threshold value.

Additionally, or alternatively, the process 500 may include determining an investment score associated with at least one of the at least one second IP asset or the entity associated with the at least one second IP asset based at least in part on the at least one second financial metric, the investment score indicating an investment value associated with at least one of the at least one second IP asset or the entity associated with the at least one second IP asset.

Additionally, or alternatively, the process 500 may include the at least one second IP asset comprising multiple IP assets, the process 500 may further comprise determining a first subcategory associated with a first subgroup of IP assets of the multiple IP assets, identifying a first group of IP assets associated with the first subcategory, identifying a third financial metric associated with the first group of IP assets, determining a second subcategory associated with a second subgroup of IP assets of the multiple IP assets, identifying a second group of IP assets associated with the second subcategory, identifying a fourth financial metric associated with the first group of IP assets, and determining the at least one second financial metric based at least in part on a first percentage associated with the third financial metric an a second percentage associated with the third financial metric, wherein at least one of the first percentage or the second are determined based at least in part on a first number of IP assets in the first subgroup of IP assets and a second number of IP assets in the second subgroup of IP assets.

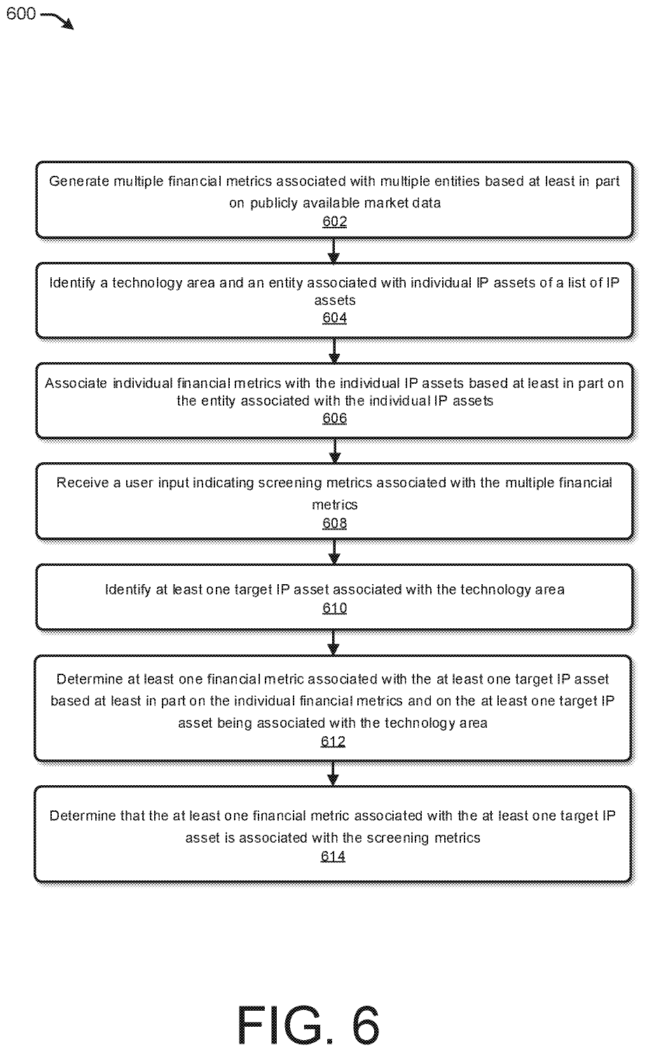

FIG. 6 illustrates an example flow diagram of an example process 600 for utilizing a target entity having IP assets generate a user interface configured to present an analysis of the IP assets. The order in which the operations or steps are described is not intended to be construed as a limitation, and any number of the described operations may be combined in any order and/or in parallel to implement process 600. The operations described with respect to the process 600 are described as being performed by an electronic device and/or a remote computing resource associated with the IP analysis platform. However, it should be understood that some or all of these operations may be performed by some or all of components, devices, and/or systems described herein.

At block 602, the process 600 may include generating multiple financial metrics associated with multiple entities based at least in part on publicly available market data. For example, the financial modeling component 246 may generate a financial metric associated with one or more entities that provide publicly available market data. For example, these entities may be publicly traded companies that provide publicly available market data to shareholders, such as, but not limited to option expiration, historic volatility, implied volatility, moneyness, open interest, option price, P/E ratio, P/B ratio, put/call ratio, share price, stock exchange, strike price, intrinsic value, premium, volume, or research and development spending. In some examples, the financial metric may be a composite metric for each individual entity that combines one or more of the market data.

At block 604, the process 600 may include identifying a technology area and an entity associated with individual IP assets of a list of IP assets. For example, the financial modeling component 246 may also categorize each IP asset into a particular technology category and/or subcategory. By way of example, a technology category may include “automotive” and the subcategories may include “ion batteries,” “charging accessories,” “lidar,” “suspension,” “body,” etc.

At block 606, the process 600 may include associating individual financial metrics with the individual IP assets based at least in part on the entity associated with the individual IP assets. For example, the financial modeling component 246 may associate the financial metric associated with each of the entities with the IP assets that are associated with each of the entities. For example, some or all of the entities (e.g., publicly traded companies) may own and/or otherwise be assignees to IP assets that are publicly available. The financial modeling component 246 may associate the financial metric for a particular entity with that entities IP assets, thereby “labeling” each IP asset with an individual financial metric. In some examples, the financial modeling component 246 may also categorize each IP asset into a particular technology category and/or subcategory. By way of example, a technology category may include “automotive” and the subcategories may include “ion batteries,” “charging accessories,” “lidar,” “suspension,” “body,” etc.

At block 608, the process 600 may include receiving a user input indicating screening metrics associated with the multiple financial metrics. For example, the screener page 402 may enable to input one or more criteria 408 (e.g., screener criteria) that may change the results displayed on the screener page 402. For example, the input criteria may include setting values (e.g., “total score greater than 70,” “annual revenue greater than $600 million,” etc.) for the metrics that cause the screener page to display the entities that satisfy the input criteria. In the example of FIG. 4, the criteria 408 are set for entities that have a total score above “70” and an annual revenue above “$600 M.” Thus, the entities 404 that are presented satisfy the criteria 408.

At block 610, the process 600 may include identifying at least one target IP asset associated with the technology area. For example, the screener page 402 may enable to input one or more criteria 408 (e.g., screener criteria) that may change the results displayed on the screener page 402. For example, the input criteria may include setting values (e.g., “total score greater than 70,” “annual revenue greater than $600 million,” etc.) for the metrics that cause the screener page to display the entities that satisfy the input criteria. In the example of FIG. 4, the criteria 408 are set for entities that have a total score above “70” and an annual revenue above “$600 M.” Thus, the entities 404 that are presented satisfy the criteria 408.

At block 612, the process 600 may include determining at least one financial metric associated with the at least one target IP asset based at least in part on the individual financial metrics and on the at least one target IP asset being associated with the technology area. For example, the screener page 402 may enable to input one or more criteria 408 (e.g., screener criteria) that may change the results displayed on the screener page 402. For example, the input criteria may include setting values (e.g., “total score greater than 70,” “annual revenue greater than $600 million,” etc.) for the metrics that cause the screener page to display the entities that satisfy the input criteria. In the example of FIG. 4, the criteria 408 are set for entities that have a total score above “70” and an annual revenue above “$600 M.” Thus, the entities 404 that are presented satisfy the criteria 408.

At block 614, the process 600 may include determining that the at least one financial metric associated with the at least one target IP asset is associated with the screening metrics. For example, the value modeling component 122 may be configured to receive user input data as described herein for indicating screener criteria used by the value modeling component 122 to determine target data representing at least one of an entity, publication, and/or product utilized to generate seeded search queries that utilize the target data to determine a representative entity and return results including one or more IP assets associated with the representative entity, one or more entities that have IP assets that are determined to be similar to the IP assets of the representative entity, market area and/or technology areas associated with the IP assets of the representative entity, revenue data associated with the market area and/or technology areas of the representative entity, revenue data associated with one or more entities that have IP assets that are determined to be similar to the IP assets of the representative entity, and/or litigation data associated with market area and/or technology areas associated with the IP assets of the representative entity.

Additionally, or alternatively, the process 600 may include generating a graphical user interface (GUI) configured to display a visual representation of at least one of: the screening metrics, an entity associated with the at least one target IP asset, and metric data associated with the at least one target IP asset, and causing the GUI to be displayed via a display device of a computing device.

Additionally, or alternatively, the process 600 may include the metric data including at least one of: a coverage metric, an opportunity metric, an exposure metric, an overall score metric, a filing velocity metric, or a diversity metric.

Additionally, or alternatively, the process 600 may include the screening metrics including at least one of option expiration, historic volatility, implied volatility, moneyness, open interest, option price, P/E ratio, PB ratio, put/call ratio, share price, stock exchange, strike price, intrinsic value, premium, volume, or research and development spending.

Additionally, or alternatively, the process 600 may include the at least one target IP asset being associated with a private corporations in which publicly available financial information is not available.

Additionally, or alternatively, the process 600 may include determining similarity scores between the individual IP assets of the list of IP assets and the at least one target IP asset, and determining the at least one financial metric associated with the at least one target IP asset based at least in part on the similarity scores being above a threshold value.

Additionally, or alternatively, the process 600 may include determining an investment score associated with at least one of the at least one target IP asset or an entity associated with the at least one target IP asset based at least in part on the at least one financial metric, the investment score indicating an investment value associated with at least one of the at least one target IP asset or the entity associated with the at least one target IP asset

Additionally, or alternatively, the process 600 may include the at least one financial metric being determined based at least in part on an average of the individual financial metrics associated with the individual IP assets, the individual IP assets having a similarity score with the at least target IP asset that is above a threshold value.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A method comprising:
generating at least one first financial metric associated with a first entity based at least in part on publicly available market data;
associating the at least one first financial metric with at least one first IP asset based at least in part on the first entity being associated with the at least one first IP asset;
identifying a technology area associated with the at least one first IP asset;
identifying at least one second IP asset associated with the technology area;
determining at least one second financial metric associated with the at least one second IP asset based at least in part on the at least one first financial metric and on the at least one second IP asset being associated with the technology area, wherein the at least one second financial metric is determined based at least in part on an average financial metric of multiple financial metrics of multiple other IP assets that have a similarity score with the at least second IP asset that is above a threshold value;
generating a graphical user interface (GUI) configured to display a visual representation of at least one of:
the at least one second financial metric; and
an entity associated with the at least one second IP asset; and
causing the GUI to be displayed via a display device of a computing device, wherein the at least one second financial metric is one of multiple financial metrics selectable via the GUI to screen multiple entities.

2. The method of claim 1, wherein at least one of the at least one first financial metric or the at least one second financial metric comprises:
option expiration;
historic volatility;
implied volatility;
moneyness;
open interest;
option price;
P/E ratio;
P/B ratio;
put/call ratio;
share price;
stock exchange;
strike price;
intrinsic value;
premium;
volume; or
research and development spending.

3. The method of claim 1, further comprising:
receiving the publicly available market data;
parsing, via one or more computer models, the publicly available market data to identify relevant market data;
inputting the relevant market data into a machine learning algorithm; and
receiving one or more outputs from the machine learning algorithm, the one or more outputs being associated with the at least one second financial metric.

4. The method of claim 3, further comprising receiving additional relevant market data identified by the machine learning algorithm based at least in part on the relevant market data used as the input to the machine learning algorithm.

5. The method of claim 1, wherein the multiple entities comprise private corporations in which publicly available financial information is not available.

6. The method of claim 1, further comprising:
determining a similarity score between the at least one first IP asset and the at least one second IP asset; and
determining the at least one second financial metric associated with the at least one second IP asset based at least in part on the similarity score being above a threshold value.

7. The method of claim 1, further comprising determining an investment score associated with at least one of the at least one second IP asset or the entity associated with the at least one second IP asset based at least in part on the at least one second financial metric, the investment score indicating an investment value associated with at least one of the at least one second IP asset or the entity associated with the at least one second IP asset.

8. The method of claim 1, wherein the at least one second IP asset comprises multiple IP assets, the method further comprising:
determining a first subcategory associated with a first subgroup of IP assets of the multiple IP assets;
identifying a first group of IP assets associated with the first subcategory;
identifying a third financial metric associated with the first group of IP assets;
determining a second subcategory associated with a second subgroup of IP assets of the multiple IP assets;
identifying a second group of IP assets associated with the second subcategory;
identifying a fourth financial metric associated with the first group of IP assets; and
determining the at least one second financial metric based at least in part on a first percentage associated with the third financial metric an a second percentage associated with the third financial metric, wherein at least one of the first percentage or the second are determined based at least in part on a first number of IP assets in the first subgroup of IP assets and a second number of IP assets in the second subgroup of IP assets.

9. A method comprising:
generating multiple financial metrics associated with multiple entities based at least in part on publicly available market data;
identifying a technology area and an entity associated with individual IP assets of a list of IP assets;
associating individual financial metrics with the individual IP assets based at least in part on the entity associated with the individual IP assets;
receiving a user input indicating screening metrics associated with the multiple financial metrics;
identifying at least one target IP asset associated with the technology area;
determining at least one financial metric associated with the at least one target IP asset based at least in part on the individual financial metrics and on the at least one target IP asset being associated with the technology area; and
determining that the at least one financial metric associated with the at least one target IP asset is associated with the screening metrics.

10. The method of claim 9, further comprising:
generating a graphical user interface (GUI) configured to display a visual representation of at least one of:
the screening metrics;
an entity associated with the at least one target IP asset; and
metric data associated with the at least one target IP asset; and
causing the GUI to be displayed via a display device of a computing device.

11. The method of claim 10, wherein the metric data includes at least one of:
a coverage metric;
an opportunity metric;
an exposure metric;
an overall score metric;
a filing velocity metric; or
a diversity metric.

12. The method of claim 9, wherein the screening metrics include at least one of:
option expiration;
historic volatility;
implied volatility;
moneyness;
open interest;
option price;
P/E ratio;
P/B ratio;
put/call ratio;
share price;
stock exchange;
strike price;
intrinsic value;
premium;
volume; or
research and development spending.

13. The method of claim 9, wherein the at least one target IP asset is associated with a private corporations in which publicly available financial information is not available.

14. The method of claim 9, further comprising:
determining similarity scores between the individual IP assets of the list of IP assets and the at least one target IP asset; and
determining the at least one financial metric associated with the at least one target IP asset based at least in part on the similarity scores being above a threshold value.

15. The method of claim 9, further comprising determining an investment score associated with at least one of the at least one target IP asset or an entity associated with the at least one target IP asset based at least in part on the at least one financial metric, the investment score indicating an investment value associated with at least one of the at least one target IP asset or the entity associated with the at least one target IP asset.

16. The method of claim 9, wherein the at least one financial metric is determined based at least in part on an average of the individual financial metrics associated with the individual IP assets, the individual IP assets having a similarity score with the at least target IP asset that is above a threshold value.

17. A system comprising:
one or more processors; and
one or more non-transitory computer-readable media comprising instructions that, when executed by the one or more processors, cause the one or more processors to perform operations comprising:
generating at least one first financial metric associated with a first entity based at least in part on publicly available market data;
identifying at least one first IP asset associated with a technology area;
associating the at least one first financial metric with the at least one first IP asset based at least in part on the first entity being associated with the at least one first IP asset;
identifying at least one second IP asset associated with the technology area;
determining at least one second financial metric associated with the at least one second IP asset based at least in part on the at least one first financial metric and on the at least one second IP asset being associated with the technology area.

18. The system of claim 17, wherein at least one of the at least one first financial metric or the at least one second financial metric comprises:
option expiration;
historic volatility;
implied volatility;
moneyness;
open interest;
option price;
P/E ratio;
P/B ratio;
put/call ratio;
share price;
stock exchange;
strike price;
intrinsic value;
premium;
volume; or
research and development spending.

19. The system of claim 17, further comprising:
generating a graphical user interface (GUI) configured to display a visual representation of at least one of:
the at least one second financial metric; and
an entity associated with the at least one second IP asset; and
causing the GUI to be displayed via a display device of a computing device, wherein the at least one second financial metric is one of multiple financial metrics selectable via the GUI to screen multiple entities.

20. The system of claim 19, wherein the multiple entities comprise private corporations in which publicly available financial information is not available.
